(19) United States
(12) Patent Application Publication
(10) Pub. No.: US 2021/0311879 A1
(43) Pub. Date: Oct. 7, 2021

(54) APPARATUS AND METHOD FOR CONTROLLING MAP DATA IN A MEMORY SYSTEM

(71) Applicant: SK hynix Inc., Gyeonggi-do (KR)

(72) Inventor: Hye Mi KANG, Gyeonggi-do (KR)

(21) Appl. No.: 16/996,243

(22) Filed: Aug. 18, 2020

(30) Foreign Application Priority Data
Apr. 7, 2020 (KR) 10-2020-0042078

(51) Int. Cl. G06F 12/10

(52) U.S. Cl. CPC G06F 12/10; G06F 2212/657

(57) ABSTRACT

A memory system includes a memory device and a controller. The memory device includes at least one open memory block. The controller is configured to program data input along with write requests from an external device in the at least one open memory block, determine a storage mode regarding map data based on a type of the write requests, and perform a map update based on the map data. The controller is further configured to determine a timing for performing the map update is determined based on the storage mode and the type of write requests.

### CROSS-REFERENCE TO RELATED APPLICATION

This patent application claims the benefit of Korean Patent Application No. 10-2020-0042078, filed on Apr. 7, 2020, the entire disclosure of which is incorporated herein by reference.

### TECHNICAL FIELD

An embodiment of this disclosure relates to a memory system, and more particularly, to an apparatus and a method for controlling map data in the memory system.

### BACKGROUND

Recently, a paradigm for a computing environment has shifted to ubiquitous computing, which enables computer systems to be accessed virtually anytime and everywhere. As a result, the use of portable electronic devices, such as mobile phones, digital cameras, notebook computers, and the like, are rapidly increasing. Such portable electronic devices typically use or include a memory system that uses or embeds at least one memory device, i.e., a data storage device. The data storage device can be used as a main storage device or an auxiliary storage device of a portable electronic device.

Unlike a hard disk, a data storage device using a nonvolatile semiconductor memory device is advantageous in that it has excellent stability and durability because it has no mechanical driving part (e.g., a mechanical arm), and has high data access speed and low power consumption. In the context of a memory system having such advantages, exemplary data storage devices include a USB (Universal Serial Bus) memory device, a memory card having various interfaces, and a solid state drive (SSD).

### BRIEF DESCRIPTION OF THE DRAWINGS

The description herein makes reference to the accompanying drawings wherein like reference numerals refer to like parts throughout the figures.

FIG. 1 illustrates a memory system according to an embodiment of the disclosure.

FIG. 2 illustrates a data processing system according to an embodiment of the disclosure.

FIG. 3 illustrates a memory system according to an embodiment of the disclosure.

FIG. 4 illustrates a storage mode regarding map data according to an embodiment of the disclosure.

FIG. 5 illustrates second map data (e.g., a P2L table) having a plurality of storage modes.

FIG. 6 illustrates a write operation performed in a memory device according to an embodiment of the disclosure.

FIG. 7 illustrates a first example of a method for operating a memory system according to an embodiment of the disclosure.

FIG. 8 illustrates a method for selecting a storage mode regarding map data according to an embodiment of the disclosure.

FIG. 9 illustrates a second example of a method for operating a memory system according to an embodiment of the disclosure.

FIG. 10 illustrates map data including map information corresponding to different types of write requests in a memory system according to an embodiment of the disclosure.

FIG. 11 illustrates a third example of a method for operating a memory system according to an embodiment of the disclosure.

In this disclosure, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

### DETAILED DESCRIPTION

Various embodiments of the disclosure are described below with reference to the accompanying drawings. Elements and features of the disclosure, however, may be configured or arranged differently to form other embodiments, which may be variations of any of the disclosed embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim does not foreclose the apparatus from including additional components (e.g., an interface, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the unit/circuit/component can be said to be configured to perform the task even when the specified blocks/unit/circuit/component is not currently operational (e.g., is not on). The blocks/units/circuits/components used with the “configured to” language include hardware-for example, circuits, memory storing program instructions executable to implement the operation, etc. Reciting that a block/unit/circuit/component is “configured to” perform one or more tasks is expressly intended not to invoke 35 U.S.C. § 112(f) for that block/unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

As used in the disclosure, the term ‘circuitry’ refers to any and all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” also covers an implementation of merely a processor (or multiple processors) or portion of a processor and its (or their) accompanying software and/or firmware. The term “circuitry” also covers, for example, and if applicable to a particular claim element, an integrated circuit for a storage device.

As used herein, these terms “first,” “second,” “third,” and so on are used as labels for nouns that they precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, first circuitry may be distinguished from second circuitry.

Further, the term “based on” is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

An embodiment of the disclosure can provide a data process system and a method for operating the data processing system, which includes components and resources such as a memory system and a host and is capable of dynamically allocating plural data paths used for data communication between the components based on usages of the components and the resources.

According to an embodiment of the disclosure, a storage mode regarding map data used to improve data input/output performance of a memory system may be changed or adjusted in response to a data input/output request. By changing the storage mode regarding the map data, resources consumed for the data input/output operation in the memory system can be reduced so that operation efficiency can be improved.

According to an embodiment of the disclosure, according to a type of write request input to the memory system, the number of open memory blocks used for programming data input along with a write request from an external device may be differently set or determined. According to an embodiment, plural pieces of data input along with random write requests may be distributed and stored in a plurality of open memory blocks, but plural pieces of data input with sequential write requests may be stored in the same open memory block. The memory system may set the storage mode regarding the map data differently according to the number of open memory blocks on which program operations are performed. Through these ways, a timing for performing a map update or a map flush according to the storage mode regarding the map data may be changed or adjusted in the memory system.

According to an embodiment of the disclosure, the memory system can reduce consumption of resources such as a cache memory and an operation margin used and allocated for an internal operation such as address translation and map data control or management, and the memory system may redistribute saved resources for processing or handling a request and/or a piece of data input from an external device so as to improve performance of the data input/output operations.

In an embodiment, a memory system can include a memory device including at least one open memory block; and a controller configured to program data input along with write requests from an external device in the at least one open memory block, determine a storage mode regarding map data based on a type of the write requests, and perform a map update based on the map data. The controller can be further configured to a timing for performing the map update can be determined based on the storage mode and the type of write requests.

By the way of example but not limitation, a number of the at least one open memory block where the data input along with the write requests can be programmed depends on the type of write requests.

The write requests can include a random write request and a sequential write request, and data corresponding to the sequential write request is programmed in a single open memory block of the at least open memory block.

The memory device can include a plurality of planes, each plane including at least one buffer capable of storing data having a size of page. The plane can include the at least one open memory block individually.

The map data can include plural pieces of second map information, each piece of second map information linking a physical address to a logical address.

The controller can be configured to determine storage mode can be determined as one of: a first storage mode where the logical address and the physical address corresponding to each piece of second map information are stored in the map data; and a second storage mode where only the logical address corresponding to each piece of second map information is stored in the map data and the physical address associated with the stored logical address is recognized by an index of the stored logical address within the map data.

The controller can be further configured to maintain the storage mode, even though the type of write requests is changed, when the storage mode regarding the map data is the first storage mode.

The controller can be further configured to either add a new piece of second map information to the map data or perform the map update, according to the type of write requests and an available space within the map data, when the storage mode regarding the map data is the second storage mode. The controller can be further configured to add the new piece of second map information to the map data by adding the logical address and the physical address corresponding to the new piece of second map information to the map data, or overwriting a physical address stored in the map data with the logical address corresponding to the new piece of second map information.

The memory device can store first map data. The map update can include an operation of updating the first map data based on the second map information when the map data is not available for storing a new piece of second map information.

In another embodiment, a method for operating a memory system can include programming data in a memory device including at least one open memory block according to a type of write requests input from an external device; determining a storage mode regarding map data based on the type of write requests; and performing a map update based on the map data, wherein the performing of the map update includes determining a timing for performing the map update based on the storage mode and the type of write requests.

By the way of example but not limitation, a number of the at least one open memory block where the data input along with the write requests can be programmed depends on the type of write requests.

The write requests can include a random write request and a sequential write request, and data corresponding to the sequential write request is programmed in a single open memory block of the at least one open memory block.

The memory device can include a plurality of planes, each plane including at least one buffer capable of storing data having a size of page. The plane can include the at least one open memory block individually.

The map data can include plural pieces of second map information, each piece of second map information linking a physical address to a logical address.

The storage mode can be determined as one of: a first storage mode where the logical address and the physical address corresponding to each piece of second map information are stored in the map data; and a second storage mode where only the logical address corresponding to each piece of second map information is stored in the map data and the physical address associated with the stored logical address is recognized by an index of the stored logical address within the map data.

The method can further include maintaining the storage mode, even though the type of write requests is changed, when the storage mode regarding the map data is the first storage mode.

The method can further include either adding a new piece of second map information to the map data or performing the map update, according to the type of write requests and an available space within the map data, when the storage mode regarding the map data is the second storage mode. The adding of the new piece of second map information to the map data includes adding the logical address and the physical address corresponding to the new piece of second map information to the map data or overwriting a physical address stored in the map data with the logical address corresponding to the new piece of second map information.

The memory device can store first map data. The map update can include an operation of updating the first map data based on the second map information when the map data is not available for storing a new piece of second map information.

In another embodiment, a controller for generating first map information and second map information used to associate different address schemes with each other for engaging plural devices with each other, each device having a different address scheme, causes one or more processors to perform operations including programming data in a memory device including at least one open memory block according to a type of write requests input from an external device; determining a storage mode regarding map data based on the type of write requests; and performing a map update based on the map data, wherein the performing of the map update includes determining a timing for performing the map update based on the storage mode and the type of write requests.

When the write requests are sequential write requests, data input along with the write requests can be programmed in a single open memory block. The determining of the storage mode includes controlling the map data regarding second map information associating a physical address with a logical address in a storage mode where only the logical address is recorded in the map data and the physical address associated with the recorded logical address is recognized by an index of the recorded logical address within the map data.

In another embodiment, an operating method of a controller can include: performing a first caching operation including caching M pieces of first physical-to-logical (P2L) information sequentially into a map cache as a result of programming sequential data into an open memory block, the map cache having a storage capacity of at least M pairs of physical and logical addresses; performing a second caching operation including caching, upon completion of the first caching operation, M pieces of second P2L information sequentially into the map cache as a result of additionally programming sequential data into the memory block; and updating, upon completion of the second caching operation, logical-to-physical (L2P) information based on the cached P2L information, wherein the second caching operation is performed by sequentially replacing M physical addresses within the cached first P2L information with M logical addresses within the second P2L information, respectively, and wherein offsets of the cached logical addresses identify physical addresses within the memory block.

Embodiments of the disclosure are described below with reference to the accompanying drawings, wherein like numbers reference like elements.

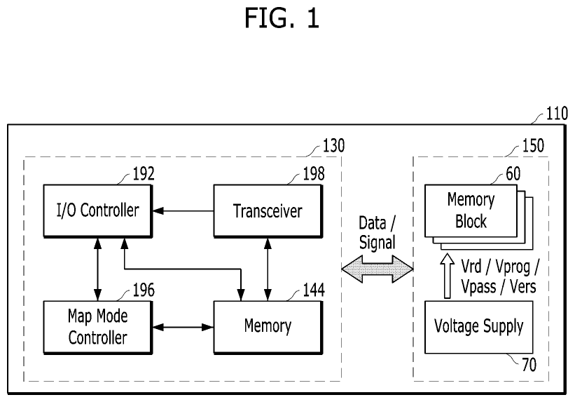

FIG. 1 illustrates a memory system according to an embodiment of the disclosure.

Referring to FIG. 1, a memory system 110 may include a memory device 150 and a controller 130. The memory device 150 and the controller 130 in the memory system 110 may be considered physically separate components or elements. The memory device 150 and the controller 130 may be connected via at least one data path. For example, the data path may include a channel and/or a way.

According to an embodiment, the memory device 150 and the controller 130 may include at least one or more components or elements functionally divided. Further, according to an embodiment, the memory device 150 and the controller 130 may be implemented with a single chip or a plurality of chips.

The memory device 150 may include a plurality of memory blocks 60. The memory block 60 may represent a group of non-volatile memory cells in which data is removed together by a single erase operation. Although not illustrated, the memory block 60 may include a page which is a group of non-volatile memory cells that store data together during a single program operation or output data together during a single read operation. For example, one memory block 60 may include a plurality of pages.

Although not shown in FIG. 1, the memory device 150 may include a plurality of memory planes or a plurality of memory dies. According to an embodiment, the memory plane may be considered a logical or a physical partition including at least one memory block 60, a driving circuit capable of controlling an array including a plurality of non-volatile memory cells, and a buffer that can temporarily store data inputted to, or outputted from, non-volatile memory cells.

In addition, according to an embodiment, the memory die may include at least one memory plane. The memory die may be understood as a set of components implemented on a physically distinguishable substrate. Each memory die may be connected to the controller 130 through a data path. Each memory die may include an interface to exchange a piece of data and a signal with the controller 130.

According to an embodiment, the memory device 150 may include at least one memory block 60, at least one memory plane, or at least one memory die. The internal configuration of the memory device 150 shown in FIG. 1 may be different according to performance of the memory system 110. The present invention is not limited to the internal configuration shown in FIG. 1.

Referring to FIG. 1, the memory device 150 may include a voltage supply circuit 70 capable of supplying at least one voltage into the memory block 60. The voltage supply circuit 70 may supply a read voltage Vrd, a program voltage Vprog, a pass voltage Vpass, or an erase voltage Vers to one or more non-volatile memory cells in the memory block 60. For example, during a read operation for reading data stored in the memory block 60, the voltage supply circuit 70 may supply the read voltage Vrd into one or more selected non-volatile memory cells in which the data is stored. During a program operation for storing data in the memory block 60, the voltage supply circuit 70 may supply the program voltage Vprog into one or more selected non-volatile memory cell(s) where the data is to be stored. Also, during a read operation or a program operation performed on the selected nonvolatile memory cell(s), the voltage supply circuit 70 may supply a pass voltage Vpass into non-selected nonvolatile memory cells. During an erasing operation for erasing data stored in non-volatile memory cells in the memory block 60, the voltage supply circuit 70 may supply the erase voltage Vers into the memory block 60.

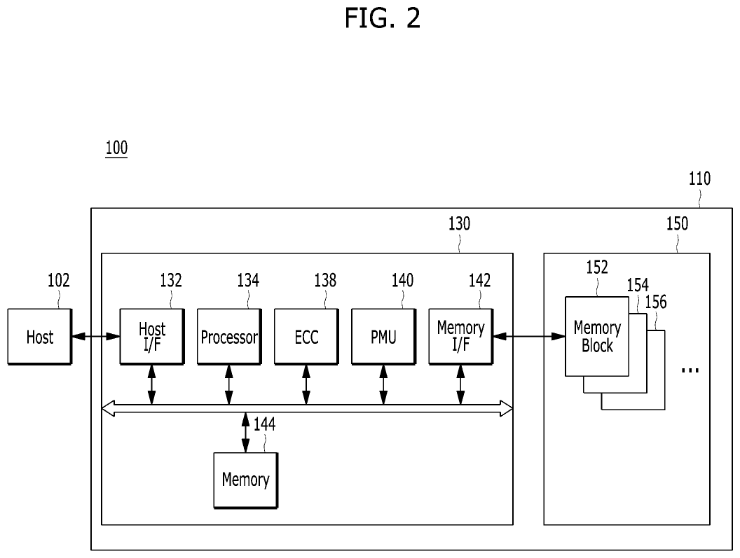

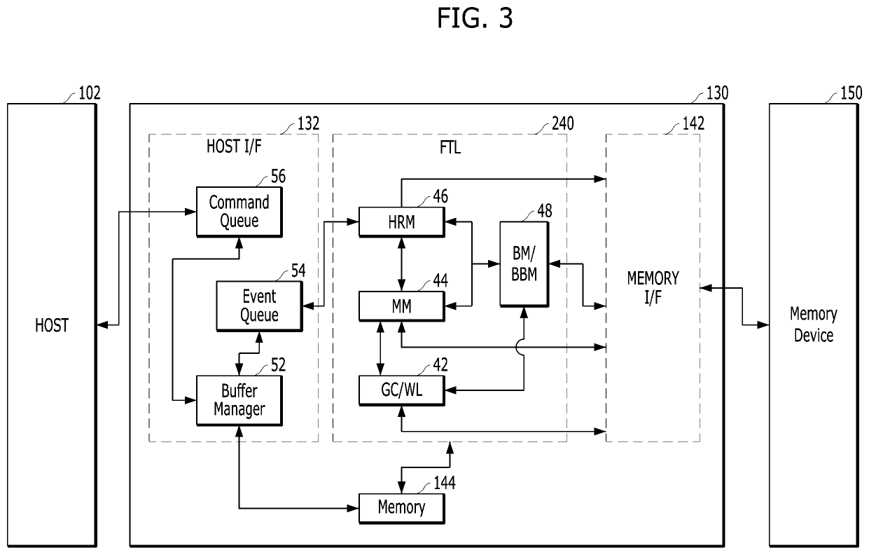

In order to store data requested by an external device (e.g., host 102 shown in FIGS. 2 and 3) in a storage space including non-volatile memory cells, the memory system 110 may perform address translation associating a file system used by the host 102 with the storage space including the non-volatile memory cells. For example, an address indicating data according to the file system used by the host 102 may be called a logical address or a logical block address, while an address indicating data stored in the storage space including the non-volatile memory cells may be called a physical address or a physical block address. When the host 102 transmits a logical address with a read request to the memory system 110, the memory system 110 searches for a physical address corresponding to the logical address and then transmits data stored in a location indicated by the physical address to the host 102. During these processes, the address translation may be performed by the memory system 110 to search for the physical address corresponding to the logical address input from the host 102.

In response to a request input from the external device, the controller 130 may perform a data input/output operation. For example, when the controller 130 performs a read operation in response to a read request input from an external device, data stored in a plurality of non-volatile memory cells in the memory device 150 is outputted to the controller 130. For a read operation, an input/output (I/O) controller 192 may perform address translation regarding a logical address input from the external device, and then transmit the read request to the memory device 150 corresponding to a physical address, obtained though the address translation, via the transceiver 198. The transceiver 198 may transmit the read request to the memory device 150 and receive data output from the memory device 150. The transceiver 198 may store data output from the memory device 150 in the memory 144. The I/O controller 192 may output data stored in the memory 144 to the external device as a result corresponding to the read request.

In addition, the I/O controller 192 may transmit data input along with a write request from the external device to the memory device 150 through the transceiver 198. After the data is stored in the memory device 150, the I/O controller 192 may transmit a response or an answer corresponding to the write request to the external device. The I/O controller 192 may update map data that associates a physical address, which shows a location where the data is stored in the memory device 150, with a logical address input along with the write request.

When the I/O controller 192 performs a data input/output operation, a map mode controller 196 may determine a storage mode regarding the map data stored in the memory 144 in response to the write request input from the external device. For example, the map mode controller 196 may recognize the write request input from the external device as being related to sequential data or random data. Depending on whether the write request input from the external device is a random write request or a sequential write request, the map mode controller 196 may change or adjust the storage mode regarding the map data.

According to an embodiment of the disclosure, data input with the random write request may be stored in a plurality of open memory blocks in the memory device 150. On the other hand, data inputted with the sequential write request may be stored in a single open memory block in the memory device 150. In an embodiment, the open memory block is a single memory block in which non-volatile memory cells are erased together. In another embodiment, the open memory block is a single superblock constituted with plural memory blocks when the memory system 110 uses superblock mapping. For example, the superblock mapping groups together a set number of adjacent logical blocks into a superblock. Superblock mapping maintains a page global directory (PGD) in RAM for each superblock. Page middle directories (PMDs) and page tables (PTs) are maintained in flash. Each LBA can be divided into a logical block number and a logical page number, with the logical block number comprising a superblock number and a PGD index offset. The logical page number comprises a PMD index offset and a PT index offset. Each entry of the PGD points to a corresponding PMD. Each entry of the PMD points to a corresponding PT. The PT contains the physical block number and the physical page number of the data. Superblock mapping, thus, comprises a four-level logical-to-physical translation and provides page-mapping.

The memory device 150 in the memory system 110 may support an interleaving operation. For example, the interleaving operation may be performed in response to a group of non-volatile memory cells, which is capable of independently performing a read operation or a write operation corresponding to a read or write request. Because each group of non-volatile memory cells can independently perform data input/output, a plurality of groups can perform plural data input/output operations in parallel. For example, when the controller 130 is operatively coupled to the memory device 150 supporting the interleaving operation based on a plane including a buffer corresponding to a page size, plural program operations corresponding to a plurality of write requests can be performed on different planes in parallel. If the memory device 150 supports the interleaving operation based on a die, a channel or a way, the controller 130 may perform operations corresponding to a plurality of write requests associated to different die, different channels or different ways in parallel. According to an embodiment of the disclosure, data input with the random write requests may be stored in a plurality of open memory blocks, each open memory block included in each group of non-volatile memory cells that can support the interleaving operation in the memory device 150. Also, data input with the sequential write requests may be stored in a single open memory block in a single group of non-volatile memory cells, even though each group of non-volatile memory cells can support the interleaving operation.

Here, the map data may include plural pieces of map information, and each piece of map information may associate a logical address with a physical address. The map information is for a data input/output operation performed by the controller 130. For example, the I/O controller 192 may use the map information for address translation, and the map information may be generated or updated after data corresponding to a write request is programmed in the memory device 150. According to an embodiment, the map data includes first map data (Logical to Physical table, L2P table) for linking a logical address to a physical address, and second map data (Physical to Logical table, P2L table) for linking a physical address to a logical address. The map mode controller 196 may determine or change a storage mode regarding the first map data and/or the second map data loaded or stored in the memory 144.

According to an embodiment, each piece of map information included in the first map data or the second map data stored in the memory device 150 may associate a single logical address with a single physical address. After the controller 130 loads and stores at least some of the first map data or the second map data, obtained from the memory device 150, in the memory 144, the controller 130 may use loaded map data for data input/output operations. When there is sufficient space allocated for the first map data or the second map data in the memory 144, a process for changing or adjusting a storage mode regarding the first map data or the second map data may incur overhead. However, a storage capacity of the memory 144 in the memory system 110 may be limited. When more pieces of map information may be loaded in the memory 144 and used for the data input/output operations, processes or operations for managing or controlling map data (e.g., loading, releasing, updating, map flushing, etc.) may be reduced. When the operations for managing and controlling the first map data or the second map data are reduced, overhead may decrease with respect to data input/output operations, which greatly affect performance of the memory system 110.

According to an embodiment, the memory device 150 may store first map data (L2P table) including plural pieces of first map information (Logical to Physical information, L2P information), each piece of first map information (L2P information) for associating a logical address with a physical address. The controller 130 may generate second map data (P2L table) to store or update plural pieces of second map information (Physical to Logical information, P2L information) generated during data input/output operations for associating a physical address with a logical address. For example, after the controller 130 programs a new piece of data to the memory device 150, the controller 130 may associate a physical address, which indicates a location where the new piece of data is programmed, with a logical address corresponding to the programmed data, to generate a new piece of second map information (P2L information). The last piece of second map information (P2L information) may indicate a location of data recently stored in the memory device 150. It may be assumed that a piece of first map information (L2P information) indicating that a specific logical address (e.g., ‘0A0’) and a first physical address (e.g., ‘123’) are associated with each other is loaded and included in the first map data (L2P table) allocated in the memory 144. After the controller 130 performs a program operation corresponding to the same logical address (e.g., ‘0A0’), the controller 130 may generate a piece of second map information (P2L information) in the memory 144. The piece of second map information (P2L information) may associate the same logical address (e.g., ‘0A0’) with a second physical address (e.g., ‘876’). In this case, it may be determined that the piece of first map information (L2P information) stored in the first map data (L2P table) is old information, and the piece of second map information (P2L information) is the latest information. The controller 130 may update the first map data (L2P table) stored in the memory device 150 based on the piece of second map information (P2L information). As described above, the controller 130 can periodically, intermittently, or as otherwise determined, perform a process for updating the first map data (L2P table) stored in the memory device 150 (referred to as map update or map flush). When the map update or map flush is performed, the second map data (P2L table) including plural pieces of second map information (P2L information) in the memory 144 may be deleted or destroyed. When an operation for programming data in the memory device 150 is performed after the map flush, the controller 130 may generate new second map data (P2L table) in the memory 144.

A timing of performing the map update or map flush may be determined differently according to an embodiment. For example, after the controller 130 performs program operations every 10 times, the controller 130 may determine whether to perform the map flush. In addition, when a space for the second map data (P2L table) allocated by the controller 130 in the memory 144 is full so that a new piece of second map information (P2L information) cannot be added to the second map data, the controller 130 may perform the map flush. According to an embodiment, the controller 130 may determine whether to perform the map flush at a set frequency (e.g., every hour, every 10 minutes, every 1 minute, etc.).

The map update or map flush is a kind of internal operation that occurs in the memory system 110 independently because the memory system 110 has its own address system that is not the same as that of the external device (e.g., physical addresses distinguishable from logical addresses used by the host 102). The external device does not transmit any request or command related to the map update or map flush. Data input/output operations may be delayed while the memory system 110 independently performs the map update or map flush. Accordingly, the map update or map flush in the memory system 110 may be recognized as overhead from the perspective of an external device. In addition, if the map update or map flush occurs too frequently, performance of the data input/output operations may be deteriorated.

On the other hand, if the map update or the map flush is not performed for a long time, any more, or is performed incorrectly valid pieces of first map information (L2P information) may increase in the first map data (L2P table) stored in the memory device 150. In this case, operation stability of the memory system 110 may be deteriorated. Or, an amount of second map information (P2L information) that is checked or referred by the controller 130 performing address translation for a read operation corresponding to a read request may increase. If the first map data (L2P table) does not include recent first map information (L2P information), the controller 130 should refer to the second map data (P2L table) stored in the memory 144 for address translation. In addition, if the map update or map flush is not performed for a long time, a size of the second map data (P2L table) stored in the memory 144 may increase, and storage efficiency of the memory 144 may deteriorate. The memory system 110 according to an embodiment of the disclosure may fix a size of space allocated for the second map data (P2L table) in the memory 144, to avoid continuously accumulating pieces of second map information (P2L information) without an upper limit.

Referring to FIG. 1, in response to a write request input from an external device, the map mode controller 196 may determine the storage mode regarding the second map data (P2L table) stored in the memory 144. The controller 130 may allocate a preset-sized space to store the second map data (P2L table). In response to the storage mode of the second map data (P2L table) selected by the map mode controller 196, a timing when the space allocated for the second map data (P2L table) is full of pieces of second map information (P2L information) may be changed. If the map update or map flush is set to be performed when the space for the second map data (P2L table) is full, a timing for performing the map update or the map flush can be changed according to the storage mode of the second map data (P2L table).

For example, when a plurality of requests transmitted from an external device are related to sequential data, the map mode controller 196 may change a storage mode regarding the map data (P2L table) so that more pieces of second map information (P2L information) can be added in the map data, as compared with another case when the plurality of requests is related to random data. Thus, a timing for the map flush when the plurality of requests is related to the sequential data may be delayed, as compared to another case when the plurality of requests is related to the random data. The controller 130 may reduce a time or an operation margin to perform operations corresponding to multiple requests for the sequential data. Through this, data input/output performance of the memory system 110 may be improved.

Hereinafter, referring to FIGS. 2 and 3, some operations performed by the memory system 110 are described in detail.

Referring to FIG. 2, a data processing system 100 in accordance with an embodiment of the disclosure is described.

Referring to FIG. 2, the data processing system 100 may include a host 102 operably engaged with a memory system 110.

The host 102 may include, for example, a portable electronic device such as a mobile phone, an MP3 player and a laptop computer, or a non-portable electronic device such as a desktop computer, a game player, a television (TV), a projector and/or the like.

The host 102 also includes at least one operating system (OS), which can generally manage, and control, functions and operations performed in the host 102. The OS can provide interoperability between the host 102 engaged with the memory system 110 and the user needing and using the memory system 110. The OS may support functions and operations corresponding to a user's requests. By way of example but not limitation, the OS can be divided into a general operating system and a mobile operating system according to mobility of the host 102. The general operating system may be split into a personal operating system and an enterprise operating system according to system requirements or a user's environment. But the enterprise operating systems can be specialized for securing and supporting high performance computing. The mobile operating system may be subject to support services or functions for mobility (e.g., a power saving function). The host 102 may include a plurality of operating systems. The host 102 may execute multiple operating systems operably engaged with the memory system 110, corresponding to a user's request. The host 102 may transmit a plurality of commands corresponding to the user's requests into the memory system 110, thereby performing operations corresponding to commands within the memory system 110.

The controller 130 in the memory system 110 may control the memory device 150 in response to a request or a command inputted from the host 102. For example, the controller 130 may perform a read operation to provide a piece of data read from the memory device 150 for the host 102, and perform a write operation (or a program operation) to store a piece of data inputted from the host 102 in the memory device 150. In order to perform data input/output (I/O) operations, the controller 130 may control and manage internal operations for data read, data program, data erase, or the like.

According to an embodiment, the controller 130 includes a host interface 132, a processor 134, error correction code (ECC) circuitry 138, a power management unit (PMU) 140, a memory interface 142, and a memory 144. Components included in the controller 130 illustrated in FIG. 2 may vary according to implementation, operation performance, or the like regarding the memory system 110. For example, the memory system 110 may be implemented with any of various types of storage devices, which may be electrically coupled with the host 102, according to a protocol of a host interface. Non-limiting examples of suitable storage devices include a solid state drive (SSD), a multimedia card (MMC) of an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like. Components in the controller 130 may be added or omitted based the particular implementation of the memory system 110.

The host 102 and the memory system 110 may include a controller or an interface for transmitting and receiving a signal, a piece of data, and the like, under a set protocol. For example, the host interface 132 in the memory system 110 may include an apparatus capable of transmitting a signal, a piece of data, and the like to the host 102 or receiving a signal, a piece of data, and the like inputted from the host 102.

The host interface 132 included in the controller 130 may receive a signal, a command (or a request), or a piece of data inputted from the host 102. That is, the host 102 and the memory system 110 may use a set protocol to transmit and receive a piece of data between each other. Examples of protocols or interfaces, supported by the host 102 and the memory system 110 for sending and receiving a piece of data, include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIE), Serial-attached SCSI (SAS), Serial Advanced Technology Attachment (SATA), Mobile Industry Processor Interface (MIPI), and the like. According to an embodiment, the host interface 132 is a kind of layer for exchanging a piece of data with the host 102 and is implemented with, or driven by, firmware called a host interface layer (HIL).

The Integrated Drive Electronics (IDE) or Advanced Technology Attachment (ATA) interface uses a cable including 40 wires connected in parallel to support data transmission and reception between the host 102 and the memory system 110. When a plurality of memory systems 110 are connected to a single host 102, the plurality of memory systems 110 may be divided into a master and a slave by using a position or a dip switch to which the plurality of memory systems 110 are connected. The memory system 110 set as the master may be used as the main memory device. The IDE (ATA) has evolved into Fast-ATA, ATAPI, and Enhanced IDE (EIDE).

Serial Advanced Technology Attachment (SATA) is a kind of serial data communication interface that is compatible with various ATA standards of parallel data communication interfaces which is used by Integrated Drive Electronics (IDE) devices. The 40 wires in the IDE interface can be reduced to six wires in the SATA interface. For example, 40 parallel signals for the IDE can be converted into 6 serial signals for the SATA to be transmitted between each other. The SATA has been widely used because of its faster data transmission and reception rate and its less resource consumption in the host 102 used for data transmission and reception. The SATA may support connection with up to 30 external devices to a single transceiver included in the host 102. In addition, the SATA can support hot plugging that allows an external device to be attached or detached from the host 102 even while data communication between the host 102 and another device is being executed. Thus, the memory system 110 can be connected or disconnected as an additional device, like a device supported by a universal serial bus (USB) even when the host 102 is powered on. For example, in the host 102 having an eSATA port, the memory system 110 may be freely detached like an external hard disk.

The Small Computer System Interface (SCSI) is a kind of serial data communication interface used for connection between a computer, a server, and/or another peripheral device. The SCSI can provide a high transmission speed, as compared with other interfaces such as the IDE and the SATA. In the SCSI, the host 102 and at least one peripheral device (e.g., the memory system 110) are connected in series, but data transmission and reception between the host 102 and each peripheral device may be performed through a parallel data communication. In the SCSI, it is easy to connect to, or disconnect from, the host 102 a device such as the memory system 110. The SCSI can support connections of 15 other devices to a single transceiver included in host 102.

The Serial Attached SCSI (SAS) can be understood as a serial data communication version of the SCSI. In the SAS, not only the host 102 and a plurality of peripheral devices are connected in series, but also data transmission and reception between the host 102 and each peripheral device may be performed in a serial data communication scheme. The SAS can support connection between the host 102 and the peripheral device through a serial cable instead of a parallel cable, so as to easily manage equipment using the SAS and enhance or improve operational reliability and communication performance. The SAS may support connections of eight external devices to a single transceiver included in the host 102.

The Non-volatile memory express (NVMe) is a kind of interface based at least on a Peripheral Component Interconnect Express (PCIe) designed to increase performance and design flexibility of the host 102, servers, computing devices, and the like equipped with the non-volatile memory system 110. Here, the PCIe can use a slot or a specific cable for connecting the host 102, such as a computing device, and the memory system 110, such as a peripheral device. For example, the PCIe can use a plurality of pins (for example, 18 pins, 32 pins, 49 pins, 82 pins, etc.) and at least one wire (e.g. x1, x4, x8, x16, etc.), to achieve high speed data communication over several hundred MB per second (e.g. 250 MB/s, 500 MB/s, 984.6250 MB/s, 1969 MB/s, and etc.). According to an embodiment, the PCIe scheme may achieve bandwidths of tens to hundreds of Giga bits per second. A system using the NVMe can make the most of an operation speed of the nonvolatile memory system 110, such as an SSD, which operates at a higher speed than a hard disk.

According to an embodiment, the host 102 and the memory system 110 may be connected through a universal serial bus (USB). The Universal Serial Bus (USB) is a kind of scalable, hot-pluggable plug-and-play serial interface that can provide cost-effective standard connectivity between the host 102 and a peripheral device such as a keyboard, a mouse, a joystick, a printer, a scanner, a storage device, a modem, a video camera, and the like. A plurality of peripheral devices such as the memory system 110 may be coupled to a single transceiver included in the host 102.

Referring to FIG. 2, the ECC circuitry 138 can correct error bits of the data to be processed in (e.g., outputted from) the memory device 150, which may include an error correction code (ECC) encoder and an ECC decoder. Here, the ECC encoder can perform error correction encoding of data to be programmed in the memory device 150 to generate encoded data into which a parity bit is added and store the encoded data in memory device 150. The ECC decoder can detect and correct errors contained in data read from the memory device 150 when the controller 130 reads the data stored in the memory device 150. In other words, after performing error correction decoding on the data read from the memory device 150, the ECC circuitry 138 can determine whether the error correction decoding has succeeded and output an instruction signal indicative of that determination (e.g., a correction success signal or a correction fail signal). The ECC circuitry 138 can use the parity bit which is generated during the ECC encoding process, for correcting the error bit of the read data. When the number of the error bits is greater than or equal to a threshold number of correctable error bits, the ECC circuitry 138 might not correct error bits but instead may output an error correction fail signal indicating failure in correcting the error bits.

According to an embodiment, the ECC circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC circuitry 138 may include any combination of circuit(s), module(s), system(s), and/or device(s) for performing suitable error correction operation based on at least one of the above described codes.

The PMU 140 may control electrical power provided in the controller 130. The PMU 140 may monitor the electrical power supplied to the memory system 110 (e.g., a voltage supplied to the controller 130) and provide the electrical power to components included in the controller 130. The PMU 140 can not only detect power-on or power-off, but also generate a trigger signal to enable the memory system 110 to back up a current state urgently when the electrical power supplied to the memory system 110 is unstable. According to an embodiment, the PMU 140 may include a device or a component capable of storing electrical power that may be discharge for use in an emergency.

The memory interface 142 may serve as an interface for handling commands and data transferred between the controller 130 and the memory device 150, to allow the controller 130 to control the memory device 150 in response to a command or a request inputted from the host 102. The memory interface 142 may generate a control signal for the memory device 150 and may process data inputted to, or outputted from, the memory device 150 under the control of the processor 134 in a case when the memory device 150 is a flash memory. For example, when the memory device 150 includes a NAND flash memory, the memory interface 142 includes a NAND flash controller (NFC). The memory interface 142 can provide an interface for handling commands and data between the controller 130 and the memory device 150. In accordance with an embodiment, the memory interface 142 can be implemented through, or driven by, firmware called a Flash Interface Layer (FIL) as a component for exchanging data with the memory device 150.

According to an embodiment, the memory interface 142 may support an open NAND flash interface (ONFi), a toggle mode or the like for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), and a toggle double data rate (DDR).

The memory 144 may be a sort of working memory in the memory system 110 or the controller 130, while storing temporary or transactional data occurred or delivered for operations in the memory system 110 and the controller 130. For example, the memory 144 may temporarily store a piece of read data outputted from the memory device 150 in response to a request from the host 102, before the piece of read data is outputted to the host 102. In addition, the controller 130 may temporarily store a piece of write data inputted from the host 102 in the memory 144, before programming the piece of write data in the memory device 150. When the controller 130 controls operations such as data read, data write, data program, data erase or etc. of the memory device 150, a piece of data transmitted or generated between the controller 130 and the memory device 150 of the memory system 110 may be stored in the memory 144. In addition to the piece of read data or write data, the memory 144 may store information (e.g., map data, read requests, program requests, etc.) for performing operations for inputting or outputting a piece of data between the host 102 and the memory device 150. According to an embodiment, the memory 144 may include a command queue, a program memory, a data memory, a write buffer/cache, a read buffer/cache, a data buffer/cache, a map buffer/cache, and the like.

In an embodiment, the memory 144 may be implemented with a volatile memory. For example, the memory 144 may be implemented with a static random access memory (SRAM), a dynamic random access memory (DRAM), or both. Although FIG. 2 illustrates, for example, the memory 144 disposed within the controller 130, the present invention is not limited to that arrangement. The memory 144 may be located within or external to the controller 130. For instance, the memory 144 may be embodied by an external volatile memory having a memory interface transferring data and/or signals between the memory 144 and the controller 130.

The processor 134 may control the overall operation of the memory system 110. For example, the processor 134 can control a program operation or a read operation of the memory device 150, in response to a write request or a read request entered from the host 102. According to an embodiment, the processor 134 may execute firmware to control the program operation or the read operation in the memory system 110. Herein, the firmware may be referred to as a flash translation layer (FTL). An example of the FTL is later described in detail, referring to FIG. 3. According to an embodiment, the processor 134 may be implemented with a microprocessor or a central processing unit (CPU).

According to an embodiment, the memory system 110 may be implemented with at least one multi-core processor. The multi-core processor is a kind of circuit or chip in which two or more cores, which are considered distinct processing regions, are integrated. For example, when a plurality of cores in the multi-core processor drive or execute a plurality of flash translation layers (FTLs) independently, data input/output speed (or performance) of the memory system 110 may be improved. According to an embodiment, the data input/output (I/O) operations in the memory system 110 may be independently performed through different cores in the multi-core processor.

The processor 134 in the controller 130 may perform an operation corresponding to a request or a command inputted from the host 102. Further, the memory system 110 may operate independently of, i.e., without a command or a request from, an external device such as the host 102. Typically, an operation performed by the controller 130 in response to the request or the command inputted from the host 102 may be considered a foreground operation, while an operation performed by the controller 130 independently (e.g., without a request or command inputted from the host 102) may be considered a background operation. The controller 130 can perform the foreground or background operation for read, write or program, erase and the like regarding a piece of data in the memory device 150. In addition, a parameter set operation corresponding to a set parameter command or a set feature command as a set command transmitted from the host 102 may be considered a foreground operation. As a background operation without a command transmitted from the host 102, the controller 130 can perform garbage collection (GC), wear leveling (WL), bad block management for identifying and processing bad blocks, or the like may be performed, in relation to a plurality of memory blocks 152, 154, 156 included in the memory device 150.

According an embodiment, some operations may be performed as either a foreground operation or a background operation. For example, if the memory system 110 performs garbage collection in response to a request or a command inputted from the host 102 (e.g., Manual GC), garbage collection can be considered a foreground operation. However, when the memory system 110 performs garbage collection independently of the host 102 (e.g., Auto GC), garbage collection can be considered a background operation.

When the memory device 150 includes a plurality of dies (or a plurality of chips) including non-volatile memory cells, the controller 130 may be configured to perform parallel processing regarding plural requests or commands inputted from the host 102 in to improve performance of the memory system 110. For example, the transmitted requests or commands may be distributed and processed simultaneously by a plurality of dies or a plurality of chips in the memory device 150. The memory interface 142 in the controller 130 may be connected to a plurality of dies or chips in the memory device 150 through at least one channel and at least one way. When the controller 130 distributes and stores pieces of data in the plurality of dies through each channel or each way in response to requests or a commands associated with a plurality of pages including nonvolatile memory cells, plural operations corresponding to the requests or the commands can be performed simultaneously or in parallel. Such a processing method or scheme can be considered as an interleaving method. Because data input/output speed of the memory system 110 operating with the interleaving method may be faster than that without the interleaving method, data I/O performance of the memory system 110 can be improved.

By way of example but not limitation, the controller 130 can recognize statuses regarding each of a plurality of channels (or ways) associated with a plurality of memory dies included in the memory device 150. The controller 130 may determine the status of each channel or each way as at least one of a busy status, a ready status, an active status, an idle status, a normal status, and/or an abnormal status. The controller's determination of which channel or way an instruction (and/or a data) is delivered through can be associated with a physical block address, e.g., which die(s) the instruction (and/or the data) is delivered into. The controller 130 can refer to descriptors delivered from the memory device 150. The descriptors can include a block or page of parameters that describe something about the memory device 150, which is data with a fixed format or structure.

For instance, the descriptors may include device descriptors, configuration descriptors, unit descriptors, and the like. The controller 130 can refer to, or use, the descriptors to determine which channel(s) or way(s) an instruction or a data is exchanged via.

Referring to FIG. 2, the memory device 150 in the memory system 110 may include the plurality of memory blocks 152, 154, 156. Each of the plurality of memory blocks 152, 154, 156 includes a plurality of nonvolatile memory cells. According to an embodiment, the memory block 152, 154, 156 can be a group of nonvolatile memory cells erased together. The memory block 152, 154, 156 may include a plurality of pages which is a group of nonvolatile memory cells read or programmed together. Although not shown in FIG. 2, each memory block 152, 154, 156 may have a three-dimensional stack structure for a high integration. Further, the memory device 150 may include a plurality of dies, each die including a plurality of planes, each plane including the plurality of memory blocks 152, 154, 156. Configuration of the memory device 150 can be different for performance of the memory system 110.

In the memory device 150 shown in FIG. 2, the plurality of memory blocks 152, 154, 156 are included. The plurality of memory blocks 152, 154, 156 can be any of different types of memory blocks such as a single-level cell (SLC) memory block, a multi-level cell (MLC) Cell) memory block, or the like, according to the number of bits that can be stored or represented in one memory cell. Here, the SLC memory block includes a plurality of pages implemented by memory cells, each storing one bit of data. The SLC memory block can have high data I/O operation performance and high durability. The MLC memory block includes a plurality of pages implemented by memory cells, each storing multi-bit data (e.g., two bits or more). The MLC memory block can have larger storage capacity for the same space compared to the SLC memory block. The MLC memory block can be highly integrated in a view of storage capacity. In an embodiment, the memory device 150 may be implemented with MLC memory blocks such as a double level cell (DLC) memory block, a triple-level cell (TLC) memory block, a quadruple-level cell (QLC) memory block and a combination thereof. The double-level cell (DLC) memory block may include a plurality of pages implemented by memory cells, each capable of storing 2-bit data. The triple-level cell (TLC) memory block can include a plurality of pages implemented by memory cells, each capable of storing 3-bit data. The quadruple-level cell (QLC) memory block can include a plurality of pages implemented by memory cells, each capable of storing 4-bit data. In another embodiment, the memory device 150 can be implemented with a block including a plurality of pages implemented by memory cells, each capable of storing five or more bits of data.

According to an embodiment, the controller 130 may use a multi-level cell (MLC) memory block included in the memory device 150 as an SLC memory block that stores one-bit data in one memory cell. A data input/output speed of the multi-level cell (MLC) memory block can be slower than that of the SLC memory block. That is, when the MLC memory block is used as the SLC memory block, a margin for a read or program operation can be reduced. The controller 130 can utilize a faster data input/output speed of the multi-level cell (MLC) memory block when using the multi-level cell (MLC) memory block as the SLC memory block. For example, the controller 130 can use the MLC memory block as a buffer to temporarily store a piece of data, because the buffer may require a high data input/output speed for improving performance of the memory system 110.

Further, according to an embodiment, the controller 130 may program pieces of data in a multi-level cell (MLC) a plurality of times without performing an erase operation on a specific MLC memory block included in the memory device 150. In general, nonvolatile memory cells have a feature that does not support data overwrite. However, the controller 130 may use a feature in which a multi-level cell (MLC) may store multi-bit data, in order to program plural pieces of 1-bit data in the MLC a plurality of times. For MLC overwrite operation, the controller 130 may store the number of program times as separate operation information when a piece of 1-bit data is programmed in a nonvolatile memory cell. According to an embodiment, an operation for uniformly levelling threshold voltages of nonvolatile memory cells can be carried out before another piece of data is overwritten in the same nonvolatile memory cells.

In an embodiment of the disclosure, the memory device 150 is embodied as a nonvolatile memory such as a flash memory, for example, as a NAND flash memory, a NOR flash memory, and the like. Alternatively, the memory device 150 may be implemented by at least one of a phase change random access memory (PCRAM), a ferroelectrics random access memory (FRAM), a spin injection magnetic memory (SU-RAM), and a spin transfer torque magnetic random access memory (STT-MRAM), or the like.

Referring to FIG. 3, a controller 130 in a memory system in accordance with another embodiment of the disclosure is described. The controller 130 cooperates with the host 102 and the memory device 150. As illustrated, the controller 130 includes a host interface 132, a flash translation layer (FTL) 240, as well as the host interface 132, the memory interface 142, and the memory 144 previously identified in connection with FIG. 2.

Although not shown in FIG. 3, in accordance with an embodiment, the ECC circuitry 138 illustrated in FIG. 2 may be included in the flash translation layer (FTL) 240. In another embodiment, the ECC circuitry 138 may be implemented as a separate module, a circuit, firmware, or the like, which is included in, or associated with, the controller 130.

The host interface 132 is for handling commands, data, and the like transmitted from the host 102. By way of example but not limitation, the host interface 132 may include a command queue 56, a buffer manager 52, and an event queue 54. The command queue 56 may sequentially store commands, data, and the like received from the host 102 and output them to the buffer manager 52 in an order in which they are stored. The buffer manager 52 may classify, manage, or adjust the commands, the data, and the like, which are received from the command queue 56. The event queue 54 may sequentially transmit events for processing the commands, the data, and the like received from the buffer manager 52.

A plurality of commands or data of the same characteristic, e.g., read or write commands, may be transmitted from the host 102, or commands and data of different characteristics may be transmitted to the memory system 110 after being mixed or jumbled by the host 102. For example, a plurality of commands for reading data (read commands) may be delivered, or commands for reading data (read command) and programming/writing data (write command) may be alternately transmitted to the memory system 110. The host interface 132 may store commands, data, and the like, which are transmitted from the host 102, to the command queue 56 sequentially.

Thereafter, the host interface 132 may estimate or predict what kind of internal operation the controller 130 will perform according to the characteristics of commands, data, and the like, which have been entered from the host 102. The host interface 132 can determine a processing order and a priority of commands, data and the like, based at least on their characteristics. According to characteristics of commands, data, and the like transmitted from the host 102, the buffer manager 52 in the host interface 132 is configured to determine whether the buffer manager should store commands, data, and the like in the memory 144, or whether the buffer manager should deliver the commands, the data, and the like into the flash translation layer (FTL) 240. The event queue 54 receives events, entered from the buffer manager 52, which are to be internally executed and processed by the memory system 110 or the controller 130 in response to the commands, the data, and the like transmitted from the host 102, so as to deliver the events into the flash translation layer (FTL) 240 in the order received.

In accordance with an embodiment, the flash translation layer (FTL) 240 illustrate in FIG. 3 may work as a multi-thread scheme to perform the data input/output (I/O) operations. A multi-thread FTL may be implemented through a multi-core processor using multi-thread included in the controller 130.

In accordance with an embodiment, the flash translation layer (FTL) 240 can include a host request manager (HRM) 46, a map manager (MM) 44, a state manager (GC/WL) 42, and a (bad) block manager BM/BBM 48. The HRM 46 can manage the events entered from the event queue 54. The MM 44 can handle or control a map data. The GC/WL 42 can perform garbage collection (GC) or wear leveling (WL). The BM/BLM 48 can execute commands or instructions onto a block in the memory device 150.

By way of example but not limitation, the HRM 46 can use the MM 44 and the BM/BLM 48 to handle or process requests according to the read and program commands, and events which are delivered from the host interface 132. The HRM 46 can send an inquiry request to the MM 44, to determine a physical address corresponding to the logical address which is entered with the events. The HRM 46 can send a read request with the physical address to the memory interface 142, to process the read request (handle the events). On the other hand, the HRM 46 can send a program request (write request) to the BM/BLM 48, to program data to a specific empty page (no data) in the memory device 150, and then, can transmit a map update request corresponding to the program request to the MM 44, to update an item relevant to the programmed data in information of mapping the logical-physical addresses to each other.

Here, the BM/BLM 48 can convert a program request delivered from the HRM 46, the MM 44, and/or the GC/WL 42 into a flash program request used for the memory device 150, to manage flash blocks in the memory device 150. In order to maximize or enhance program or write performance of the memory system 110 (see FIG. 2), the BM/BLM 48 may collect program requests and send flash program requests for multiple-plane and one-shot program operations to the memory interface 142. In an embodiment, the BM/BLM 48 sends several flash program requests to the memory interface 142 to enhance or maximize parallel processing of the multi-channel and multi-directional flash controller.

On the other hand, the BM/BLM 48 can be configured to manage blocks in the memory device 150 according to the number of valid pages, select and erase blocks having no valid pages when a free block is needed, and select a block including the least number of valid pages when it is determined that garbage collection should be performed. The GC/WL 42 can perform garbage collection to move the valid data to an empty block and erase the blocks containing the moved valid data so that the BM/BLM 48 may have enough free blocks (empty blocks with no data). If the BM/BLM 48 provides information regarding a block to be erased to the GC/WL 42, the GC/WL 42 could check all flash pages of the block to be erased to determine whether each page is valid. For example, to determine validity of each page, the GC/WL 42 can identify a logical address recorded in an out-of-band (00B) area of each page. To determine whether each page is valid, the GC/WL 42 can compare the physical address of the page with the physical address mapped to the logical address obtained from the inquiry request. The GC/WL 42 sends a program request to the BM/BLM 48 for each valid page. A mapping table can be updated through the update of the MM 44 when the program operation is complete.

The MM 44 can manage a logical-physical mapping table. The MM 44 can process requests such as queries, updates, and the like, which are generated by the HRM 46 or the GC/WL 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the MM 44 may send a read request to the memory interface 142 to load a relevant mapping table stored in the memory device 150. When the number of dirty cache blocks in the MM 44 exceeds a certain threshold, a program request can be sent to the BM/BLM 48 so that a clean cache block is made and the dirty map table may be stored in the memory device 150.

On the other hand, when garbage collection is performed, the GC/WL 42 copies valid page(s) into a free block, and the HRM 46 can program the latest version of the data for the same logical address of the page and currently issue an update request. When the GC/WL 42 requests the map update in a state in which copying of valid page(s) is not completed normally, the MM 44 might not perform the mapping table update. It is because the map request is issued with old physical information if the GC/WL 42 requests a map update and a valid page copy is completed later. The MM 44 may perform a map update operation to ensure accuracy only if the latest map table still points to the old physical address.

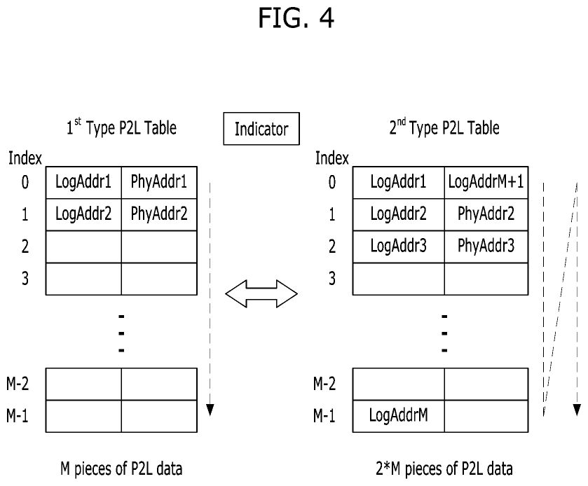

FIG. 4 illustrates a storage mode regarding map data according to an embodiment of the disclosure. Specifically, FIG. 4 shows a storage mode regarding the second map data (P2L table) stored in the memory 144 shown in FIGS. 1 to 3.

Referring to FIG. 4, the second map data (P2L table) may be established in two different storage modes (1st Type P2L table, 2nd Type P2L table). When a size in the memory 144 allocated for the second map data (P2L table) is not changed, an amount of the second map information (P2L information) that may be added to the second map data (P2L table) may be varied based on the storage mode. According to an embodiment, the memory system 110 may determine the storage mode regarding the second map data (P2L table) as one of two different storage modes (1st Type P2L table, 2nd Type P2L table) in response to a type of write requests. According to an embodiment, the controller 130 may check and control the storage mode regarding the second map data (P2L table) through an indicator indicating the storage mode regarding the second map data (P2L table).

Although not shown, according to an embodiment, a piece of second map information (P2L information) may include the logical address and the physical address, as well as a parameter, a variable, or etc. used for controlling the second map data (P2L table). Because such parameter, variable, etc. might not be differently stored depending on the storage mode regarding the second map data (P2L table), detailed description about the parameter, the variable, or etc. is omitted in FIG. 4.

The second map data (1st Type P2L table) controlled in a first storage mode may be suitable when data corresponding to write requests is stored in a plurality of open memory blocks. For example, pieces of data corresponding to random write requests may be distributed and stored in the plurality of open memory blocks. The open memory block in which the piece of data corresponding to the random write request is to be stored may be determined based on a workload of tasks performed on each die or plane in the memory device 150. It is assumed that there are three open memory blocks in one or more specific planes. When delivering the random write request and corresponding data to one of the three open memory blocks, the controller 130 can check which one has the smallest workload among the three open memory blocks (e.g., an open memory block where no operation is performed or the least data input/output operation is performed or scheduled). Plural pieces of data corresponding to plural random write requests may be stored in a plurality of open memory blocks. In this case, the second map data (1st Type P2L table) with the first storage mode can include a piece of the second map information (P2L information), each associated with each piece of data, including a logical address (e.g., LogAddr1, LogAddr2) associated with a piece of data stored in the plurality of open memory blocks and a physical address (e.g., PhyAddr1, PhyAddr2) indicating a location where the piece of data is stored among the plurality of open memory blocks. The second map data (1st Type P2L table) with the first storage mode may include M pieces of second map information (P2L information) sequentially recorded along the indexes 0 to M−1. Here, M may be an integer of 2 or more.

The second map data (2nd Type P2L table) controlled in a second storage mode may be suitable when data corresponding to write requests is stored in a single open memory block. For example, plural pieces of data corresponding to sequential write requests may be stored in a single open memory block sequentially. The open memory block in which a piece of data corresponding to a sequential write request is to be stored is not determined based on a workload of tasks performed on each die or each plane in the memory device 150. Based on continuous sequential write requests, a current piece of data may be sequentially stored in the same open memory block which a previous piece of data was programmed. It is assumed that there are three open memory blocks in one or more specific planes. Before delivering the sequential write request and the piece of data to the corresponding plane, the controller 130 can determine an open memory block in which the piece of data is to be stored. The open memory block can be the same open memory block in which the piece of data corresponding to the previous sequential write request is stored among the three open memory blocks (e.g., the second open memory block among the three open memory blocks). Accordingly, plural pieces of data corresponding to plural sequential write requests may be stored in the same open memory block. In this case, the second map data (2nd Type P2L table) with the second storage mode can include a piece of the second map information (P2L information) including a logical address (e.g., LogAddr1, LogAddr2, LogAddr3) associated with the data stored in the same open memory block. Because plural pieces of data are sequentially programmed in the same open memory block, the second map data (2nd Type P2L table) with the second storage mode does not include a physical address (e.g., PhyAddr1, PhyAddr2) indicating a location where the piece of data is stored. But, an index of items (i.e., an offset of the logical address within the second map information (P2L information)) in the second map data (2nd Type P2L table) with the second storage mode may correspond to an order of the physical addresses (e.g., PhyAddr1, PhyAddr2). Because the controller 130 does not add physical addresses to the second map data (2nd Type P2L table) with the second storage mode, 2M pieces of second map information (P2L information) may be sequentially recorded along the indexes 0 to M−1 of the second map data (2nd Type P2L table) with the second storage mode. Here, M may be an integer of 2 or more.

According to an embodiment, while adding M (0 to M−1) pieces of second map information (P2L information) to the second map data (2nd Type P2L table) controlled in the second storage mode, the M pieces of second map information (P2L information) may be stored in the same format as the first storage mode. For example, logical addresses LogAddr1, LogAddr2, LogAddr3, . . . , LogAddrM and physical addresses PhyAddr1, PhyAddr2, PhyAddr3, . . . , PhyAddrM corresponding to the M pieces of second map information (P2L information) are first added to the second map data (2nd Type P2L table) with the second storage mode. Thereafter, the controller 130 may add a logical address LogAddr(M+1) corresponding to the (M+1)th piece of second map information (P2L information) to a position where the physical address PhyAddr1 corresponding to the first piece of second map information (P2L information) is stored. That is, the physical address PhyAddr1 corresponding to the first piece of second map information (P2L information) may be overwritten with the logical address LogAddr(M+1) corresponding to the (M+1)th piece of second map information (P2L information). Regarding (M+1)th to 2Mth pieces of second map information (P2L information), the previously added physical addresses may be overwritten with new logical addresses sequentially.

The (M+1)th piece of second map information (P2L information) may not be suitable for the second map data (2nd Type P2L table) controlled in the second storage mode. In this case, the controller 130 may perform a map update based on M pieces of second map information (P2L information) which have been stored in the second map data (2nd Type P2L table) with the second storage mode. After performing the map update, the controller 130 may terminate the second storage mode regarding the second map data (P2L table) and control the second map data (P2L table) in the first storage mode. Even if the (M+1)th piece of second map information (P2L information) cannot be added to the second map data (2nd Type P2L table) operated in the second storage mode, the map update based on the second map data (2nd Type P2L table) with the second storage mode might not be earlier than that based on the second map data (1st Type P2L table) controlled in the first storage mode. For example, since processes of adding the first M pieces of second map information (P2L information) to the second map data (P2L table), controlled in the first and second storage modes, are not substantially different in two different storage modes, deterioration of performance of the memory system 110 operating in the first or second storage modes may be avoided. On the other hand, according to an embodiment of the disclosure, when the memory system 110 controls the second map data (2nd Type P2L table) in the second storage mode, the timing for performing the map update may be the same, or delayed, as another case when controlling the second map data (1st Type P2L table) in the first operation mode, so that the input/output performance of the memory system 110 can be improved.

When data corresponding to sequential write requests is stored, the second map data (2nd Type P2L table) controlled in the second storage mode may store pieces of second map information (P2L information) twice the second map data (1st Type P2L table) controlled in the first storage mode. It is presumed that a size of space allocated for the second map data in the memory 144 is not varied according to the storage mode. When the second map data (2nd Type P2L table) controlled in the second storage mode stores pieces of the second map information (P2L information) twice that of the second map data (1st Type P2L table) controlled in the first storage mode, the timing for performing the map update or map flush may be delayed or postponed. When storing data corresponding to a plurality of sequential write requests, the map update or map flush would be performed after M pieces of data have been programmed if the second map data (1st Type P2L table) is controlled in the first storage mode. On the other hand, if the second map data (2nd Type P2L table) is controlled in the second storage mode when storing data corresponding to a plurality of sequential write requests, the map update or map flush could be performed after 2M pieces of second map information (P2L information) are added to the second map data (2nd Type P2L table) controlled in the second storage mode. Going down or lowering a frequency of updating or flushing the map data the frequency may improve or enhance data input/output performance of the memory system 110.

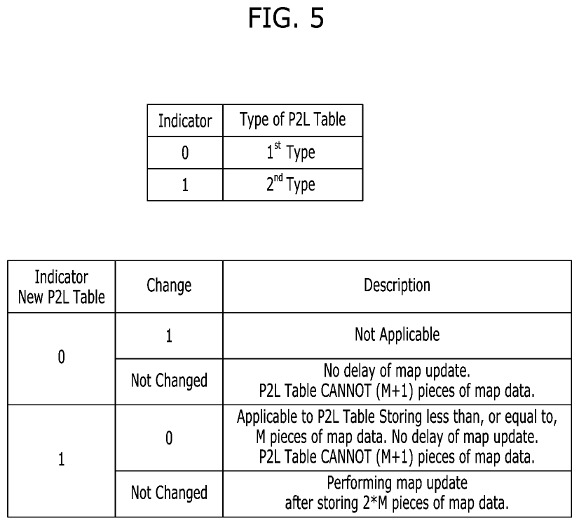

FIG. 5 illustrates the second map data (e.g., a P2L table) controlled in one of a plurality of storage modes.

Referring to FIG. 5, the second map data (P2L table) may be controlled in a plurality of storage modes. A plurality of storage modes can be identified through the identifier. For example, it is assumed that the second map data (P2L table) is controlled in one of two storage modes and the storage mode is recognized by a 1-bit identifier. When the identifier is ‘0’, the second map data (P2L table) may store one or more pieces of second map information (P2L information) into the second map data (1st Type P2L table) with the first storage mode. On the other hand, the identifier of ‘1’ may indicate that the second map data (P2L table) can store one or more of second map information (P2L information) into the second map data (2nd Type P2L table) with the second storage mode.

After the map update is performed, new second map data (P2L table) may be prepared or established in the memory 144. The second map data (P2L table) may be initially provided with the identifier of ‘0’. For example, when both the logical address and the physical address are to be associated with each other through a random write operation, to the second map data (1st Type P2L table) in the first storage mode, the controller 130 may provide the second map data (P2L table) having the identifier ‘0’. The identifier of the second map data (P2L table) might not be changed from ‘0’ to ‘1’ until a piece of second map information (P2L information) can no longer be added to the second map data (1st Type P2L table) in the first storage mode. That is, the second map data (P2L table) having the identifier ‘0’ or the second map data (1st Type P2L table) in the first storage mode can always store a piece of second map information (P2L information) including both a logical address and a physical address.

Referring to FIGS. 4 and 5, when a (M+1)th piece of second map information (P2L information) is generated after M pieces of second map information (P2L information) are added to the second map data (P2L table) having the identifier ‘0’ or the second map data (1st Type P2L table) in the first storage mode, the controller 130 can perform the map update. For example, after the (M−1) pieces of second map information (P2L information) corresponding to a random write request are added to the second map data (1st Type P2L table) with the first storage mode, the controller 130 subsequently perform a program operation corresponding to a sequential write request to generate the Mth piece of second map information (P2L information). Even if the Mth piece of second map information (P2L information) corresponding to the sequential write request is generated, the controller 130 may add the Mth piece of second map information (P2L information) including a logical address and a physical address to the second map data (P2L table) when the current second map data (1st Type P2L table) is controlled in the first storage mode with the identifier ‘0’. However, when the (M+1)th piece of second map information (P2L information) corresponds to the sequential write request, the controller 130 may prepare the second map data (P2L table) having the identifier ‘1’ after the map update.

When the controller 130 provides the second map data (P2L table) having the identifier ‘1’, the controller 130 may change the storage mode regarding the second map data (P2L table) in response to a type of write requests or write operations. It may be assumed that M pieces of second map information (P2L information) corresponding to sequential write requests are added to the second map data (2nd Type P2L table) with the second storage mode, and then the (M+1)th piece of second map information (P2L information) corresponding to the sequential write request is sequentially generated. The controller 130 does not need to change the identifier of the second map data (2nd Type P2L table) with the second storage mode, and the controller 130 can delay a timing for performing the map update after adding the (M+1)th to 2Mth pieces of second map information (P2L information) to the second map data (2nd Type P2L table) with the second storage mode. Although not shown, after storing M pieces of second map information (P2L information) corresponding to sequential write requests in the second map data (2nd Type P2L table) with the second storage mode, it may be assumed that (M+1)th piece of second map information (P2L information) corresponding to the random write request has occurred. In this case, the controller 130 performs the map update based on the M pieces of second map information (P2L information) stored in the second map data (2nd Type P2L table) with the second storage mode, and then sets the identifier of the new second map data (P2L table) as ‘0.’

After adding the M/2 pieces of second map information (P2L information) corresponding to sequential write requests to the second map data (P2L table) having the identifier ‘1’ or the second map data (2nd Type P2L table) with the second storage mode, the controller 130 may generate the (M/2+1)th piece of second map information (P2L information) corresponding to a random write request. Referring to FIGS. 4 and 5, because M pieces of second map information (P2L information) has not yet been added to the second map data (2nd Type P2L table) with the second storage mode and thus the second map data (2nd Type P2L table) with the second storage mode has an available space, the controller 130 can add the (M/2+1)th piece of second map information (P2L information) corresponding to a random write request to the second map data (2nd Type P2L table) with the second storage mode. After adding the (M/2+1)th piece of second map information (P2L information) corresponding to a random write request to the second map data (2nd Type P2L table) with the second storage mode, the controller 130 may change the identifier from ‘1’ to ‘0’. Before the (M/2+1)th piece of second map information (P2L information) corresponding to a random write request is added to the second map data (2nd Type P2L table) with the first storage mode (the identifier is changed from ‘1’ to ‘0’), the M/2 pieces of second map information (P2L information) previously added to the second map data (2nd Type P2L table) controlled in the second storage mode may correspond to sequential write requests. But, as illustrated in FIG. 4, both logical and physical addresses corresponding to each of the M/2 pieces of second map information (P2L information) corresponding to the sequential write requests may be added to the second map data (2nd Type P2L table) with the second storage mode. Therefore, even if the controller 130 changes the identifier from ‘1’ to ‘0’, an error or a malfunction might not occur in the M/2 pieces of second map information (P2L information) previously added to the second map data (P2L table), which is previously controlled in the second storage mode and currently controlled in the first storage mode, used for the map update.

Referring to FIGS. 4 and 5, as compared to a memory system controlling the second map data (1st Type P2L table) in the first storage mode only, the memory system 110 selectively controls the second map data (P2L table) in the first storage mode (1st Type P2L table) or the second storage mode (2nd Type P2L table), so that the timing for performing the map update may be the same or delayed. In addition, as compared to a memory system controlling the second map data (1st Type P2L table) in the first storage mode only, the timing for performing the map update might not be advanced even if the memory system 110 selectively controls the second map data (P2L table) in the first storage mode (1st Type P2L table) or the second storage mode (2nd Type P2L table). Through these operations, it is possible to improve I/O performance of the memory system 110, as well as it is possible to reduce a possibility that the I/O performance of the memory system 110 is deteriorated.

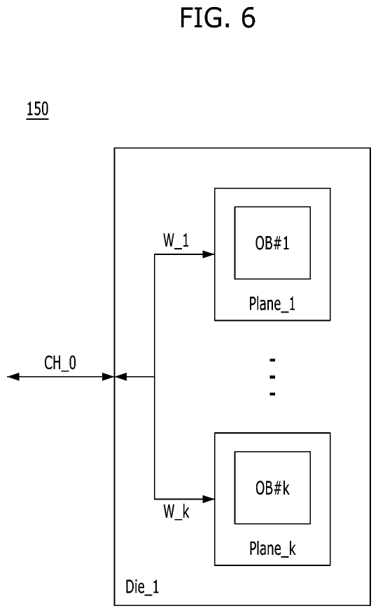

FIG. 6 illustrates a write operation performed in a memory device according to an embodiment of the disclosure.

Referring to FIG. 6, the memory device 150 may include a memory die Die1. The memory die Die1 may include a plurality of planes Plane_1, . . . , Plane_k. Here, k is an integer of 2 or more. Each of the plurality of planes Plane_1, . . . , Plane_k may include at least one open memory block OB #1, . . . , OB #k. According to an embodiment, each of the planes Plane_1, . . . , Plane_k may include at least one open memory block.

The memory die Die1 may be connected to the controller 130 through a single channel CH_0. The memory device 150 may include a plurality of memory dies connected to the controller 130 through a plurality of channels.

The memory die Die1 is connected to the channel CH_0, and the channel CH_0 is connected to each of a plurality of planes Plane_1, . . . , Plane_k included in the corresponding memory die Die1 via a plurality of ways W_1, . . . , W_k.

According to an embodiment, the controller 130 connected to the memory die Die1 may select at least some among the plurality of open memory blocks OB #1, . . . , OB #k included in at least one plane (e.g., Plane_1), based on a type of write requests, and program data associated with a write request in one or more selected open memory blocks. The controller 130 may program 5 pieces of data, each piece associated with each of 5 random write requests, in 3 open memory blocks in a specific plane or in 5 open memory blocks, each open memory block included in each of 5 planes. For example, the controller 130 may distribute the 5 pieces of data and store distributed pieces of data in three open memory blocks OB #1, OB #2, OB #3 in a plurality of planes Plane_1, . . . , Plane_k. One piece of data is stored in the first open memory block OB #1, two pieces of data are stored in the second open memory block OB #2, and two pieces of data are stored in the third open memory block OB #3. In another example, two pieces of data are stored in the first open memory block OB #1 and three pieces of data are stored in the third open memory block OB #3.

It is assumed that the controller 130 stores five pieces of data corresponding to five sequential write requests in a first plane Plane_1. If the controller 130 stores a first piece of data among the five pieces of data in the first open memory block OB #1 in the first plane Plane_1, all the remaining four pieces of data are also stored in the same first open memory block OB #1. The controller 130 may store all data corresponding to the sequential write requests in the same open memory block. However, when no more data can be programmed in the open memory block, the controller 130 may sequentially store unprogrammed data in a new open memory block. For example, after storing a second piece of data among the five pieces of data corresponding to the five sequential write requests in the first open memory block OB #1, the controller 130 stores a third piece of data in the first open memory block OB #1 if there is an empty (blank) space (or page). But, if there is no available page, the controller 130 closes the first open memory block OB #1 and determines a new open memory block. The third to fifth pieces of data among the five pieces of data may be sequentially stored in the new open memory block.

For example, when storing plural pieces of data corresponding to sequential write requests in a specific memory block of the memory device 150, the controller 130 might not record a physical address (e.g., a block number and a page number) indicating where data is stored. If the controller 130 recognize where the first piece of data is stored, the controller 130 can estimate locations in which the rest pieces of data are stored because plural pieces of data are programmed sequentially in the same memory block. When the controller 130 generates the second map data (P2L table) based on the location where the first piece of data is stored, the second map data (2nd Type P2L table) controlled in the second storage mode as described in FIG. 4 can include plural pieces of second map information (P2L information), each piece corresponding to each piece of data.

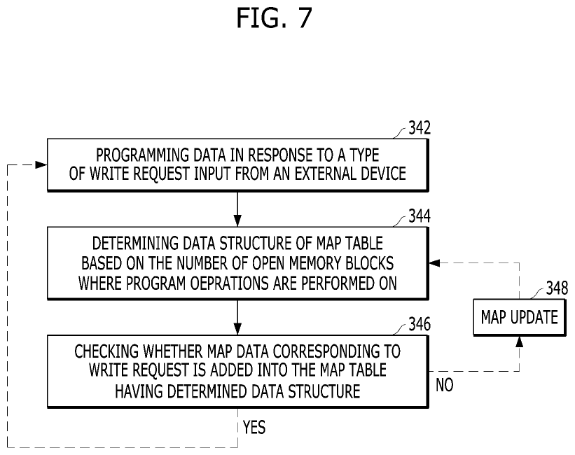

FIG. 7 illustrates a first example of a method for operating a memory system according to an embodiment of the disclosure.

Referring to FIG. 7, a method for operating the memory system can include programming data in a memory device in response to a type of write requests input from an external device (step 342), determining a data structure regarding a map table based on the number of open memory blocks where program operations are performed (step 344), and checking whether a piece of map data corresponding to a write request can be added in the map table having determined data structure (step 346). Herein, the map table may correspond to the second map data (P2L table), and the data structure regarding the map table may be determined by the storage mode. Further, a piece of map data may correspond to the piece of second map information (P2L information).

Referring to FIGS. 1 to 7, after receiving a write request input from the host 102, the memory system 110 may store data in the memory device 150 in response to the type of write request (step 342). The write request input from the host 102 to the memory system 110 may be categorized into a random write request and a sequential write request. The memory system 110 may determine how to store data input with write requests in the memory device 150 in response to the type of write requests. According to an embodiment, the memory system 110 may distribute and store plural pieces of data corresponding to plural random write requests in a plurality of open memory blocks, or may store plural pieces of data corresponding to plural sequential write requests in a single open memory block.

The memory system 110 may determine the storage mode regarding the map table in response to the number of open memory blocks on which the program operations are performed (step 344). Here, the map table stored in the memory 144 may include the second map data (P2L table) constituted with plural pieces of second map information (P2L information), each piece capable of associating a physical address with a logical address. Referring to FIGS. 1 to 7, the memory system 110 may determine a storage mode regarding the second map data (P2L table). For example, when program operations are performed in a single open memory block, the memory system 110 may determine that the second map data (P2L table) is controlled in the second storage mode so that the second map data (P2L table) does not include a physical address. When the program operations are performed in a plurality of open memory blocks, the memory system 110 may determine that the second map data (P2L table) is controlled in the first storage mode including a logical address as well as a physical address.

Also, the memory system 110 may determine whether the second map information (P2L information) can be added to the second map data (2nd Type P2L table) with the second storage mode (step 346). If a new piece of second map information (P2L information) cannot be stored in the second map data (2nd Type P2L table) with the second storage mode (NO in step 346), the memory system 110 may perform the map update or map flush (step 348). On the other hand, if it is possible to add the new piece of second map information (P2L information) to the second map data (2nd Type P2L table) with the second storage mode (YES in step 346), the memory system can store another piece of data in the memory device in response to the type of write requests (step 342).

For example, whether to add a piece of second map information (P2L information) generated by a program operation may depend on the storage mode regarding the second map data (P2L table) established in the memory 144 and the type of write requests to the second map data (P2L table). For example, if the second map data (P2L table) in the memory 144 is the second map data (2nd Type P2L table) with the second storage mode, a piece of data associated with a current random write request can be programmed in an open memory block which is different from an open memory block in which a piece of data was programmed through a previous write operation. According to an embodiment, if the second map data (2nd Type P2L table) controlled in the second storage mode can store a piece of second map information (P2L information) generated by the write operation corresponding to the current random write request, the memory system 110 may store the piece of second map information (P2L information) including the logical address and the physical address in the second map data (2nd Type P2L table) controlled in the second storage mode.

After the memory system 110 receives a plurality of write requests, plural pieces of data corresponding to the plurality of write requests may be stored in the memory device 150. When the plurality of write requests are of the same type, the memory system 110 does not need to adjust or change the storage mode regarding the second map data (P2L table). However, when the plurality of write requests includes both a random write request and a sequential write request, the memory system 110 may change or adjust the storage mode regarding the second map data (P2L table).

For example, it may be assumed that the memory system 110 receives plural pieces of data associated with 3 random write requests and then receives plural pieces of data associated with 20 sequential write requests. In addition, it is assumed that the second map data (1st Type P2L table) in the memory 144 is controlled in the first storage mode and the second map data (P2L table) may have a storage capacity of 10 pieces of second map information (P2L information). The memory system 110 programming the plural pieces of data associated with 3 random write requests in the memory device 150 may add 3 pieces of second map information (P2L information) to the second map data (1st Type P2L table) controlled in the first storage mode. According to an embodiment, the memory system 110 may sequentially add plural pieces of second map information (P2L information), generated while performing operations corresponding to the 20 sequential write requests, to second map data (1st Type P2L table) controlled in the first storage mode. However, even if a piece of second map information (P2L information) is generated after the operation corresponding to a sequential write request is performed, both the logical address and the physical address may be added to the second map data (1st Type P2L table) controlled in the first storage mode. When 7 pieces of second map information (P2L information) corresponding to 7 sequential write requests are added to the second map data (1st Type P2L table) with the first storage mode, an 8th piece (a new) piece of second map information (P2L information) cannot be added to the second map data (1st Type P2L table) controlled in the first storage mode. At this time, the memory system 110 may perform the map flush or map update (step 348).

The memory system 110 can recognize that the second map data (P2L table), used for performing the map flush or map update, includes 3 pieces of second map information (P2L information) corresponding to random write requests and 7 pieces of second map information (P2L information) corresponding to sequential write requests. According to an embodiment, the memory system 110 may determine a storage mode regarding the second map data (P2L table) after the map flush or map update, based on a history of the write requests. In the above-described case, even if the second map data (1st Type P2L table) is operated in the first storage mode before the map update, the memory system 110 may set the second map data (2nd Type P2L table) with the second storage mode. For example, the map mode controller 194 described in FIG. 1 may change the storage mode regarding the second map data (P2L table).

While the second map data (1st Type P2L table) controlled in the first storage mode has the storage capacity of 10 pieces of second map information (P2L information), the second map data (2nd Type P2L table) with the second storage mode can store 20 pieces of second map information (P2L information). After generating the second map data (2nd Type P2L table) with the second storage mode, the memory system 110 can perform program operations corresponding to the remaining 13 sequential write requests among the 20 sequential write requests. All 13 pieces of second map information (P2L information) generated after the program operations may be added to the second map data (2nd Type P2L table) controlled in the second storage mode. Through this procedure, the map flush or map update may be delayed so that the memory system 110 may complete operations for programing plural pieces of data associated with the 20 sequential write requests to the memory device 150 more quickly.

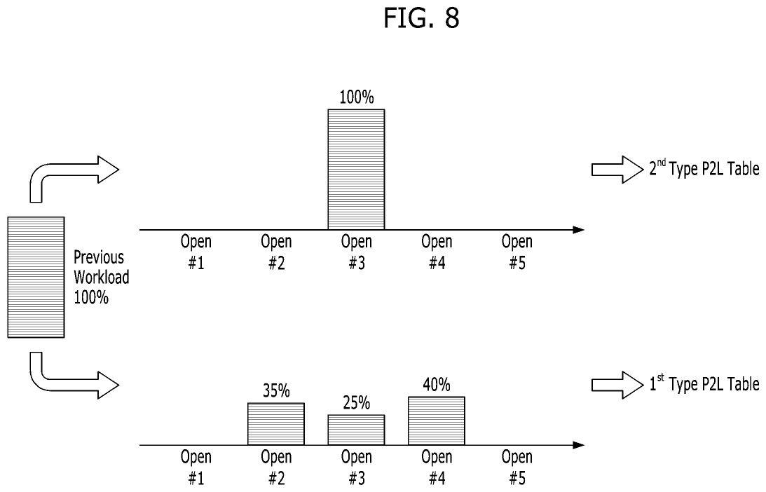

FIG. 8 illustrates a method for selecting a storage mode regarding map data according to an embodiment of the disclosure. Specifically, FIG. 8 describes a method in which the memory system 110 determines a storage mode of the second map data (P2L table) stored in the memory 144. The memory device 150 may include five open memory blocks Open #1, Open #2, Open #3, Open #4, Open #5. According to an embodiment, the five open memory blocks Open #1, Open #2, Open #3, Open #4, Open #5 may be included in at least one plane or at least one die.

Referring to FIG. 8, the memory system 110 may analyze or monitor a workload of tasks that have already been performed or scheduled. Depending on an embodiment, the workload of tasks already performed may include a write operation performed within a set margin. For example, write operations completely performed in the memory system 110 for the last 10 minutes may be regarded as the workload of tasks already performed. The number of write operations completely performed for 10 minutes may be different depending on user's usage pattern. If 100 write requests and data corresponding to each write request (e.g., 100 pieces of data) are stored in the memory device 150 for 10 minutes, the workload of tasks already performed can be understood as 100 write operations corresponding to 100 write requests. Here, it is assumed that the write operations are performed in units of pages, 100 pieces of data may be individually stored in 100 pages. If 100 pieces of data associated with 100 write requests are all stored in the same third open memory block Open #3, the memory system 110 may determine to establish the second map data (P2L table) stored in the memory 144 with the second storage mode (2nd Type).

100 pieces of data associated with 100 write requests may be distributed and stored in a plurality of open memory blocks. Referring to FIG. 8, 35 pieces of data are stored in the second open memory block Open #2, 25 pieces of data are stored in the third open memory block Open #3, and 40 pieces of data can be stored in the fourth open memory block Open #4. In this case, the memory system 110 may determine that the second map data (1st Type P2L table) is operated in the first storage mode.

According to another embodiment, the workload of tasks already performed may include a set number of scheduled write operations regardless of an operation time/margin determined for each write operation. For example, the workload of tasks that has already been performed may include write operations corresponding to 200 write requests. The memory system 110 may check whether plural pieces of data are stored in a single open memory block or a plural open memory blocks through the write operations corresponding to the 200 write requests. As described above, the memory system 110 determines a storage mode of the second map data (P2L table) stored in the memory 144 in response to the number of open memory blocks in which the write operations corresponding to the 200 write requests have been performed.

According to another embodiment, the workload of tasks already performed may be determined based on the second map data (P2L table) used for performing the map flush or map update. Write operations corresponding to the pieces of second map information (P2L information) included in the second map data (P2L table) at the time of map flush or map update may be regarded as the workload of tasks already performed. If the pieces of second map information (P2L information) added to the second map data (P2L table) is 100, the workload of tasks already performed may correspond to the number of open memory blocks in which write operations corresponding to 100 write requests have been performed. The storage mode of the second map data (P2L table) stored in the memory 144 may be determined based on the workload of tasks.

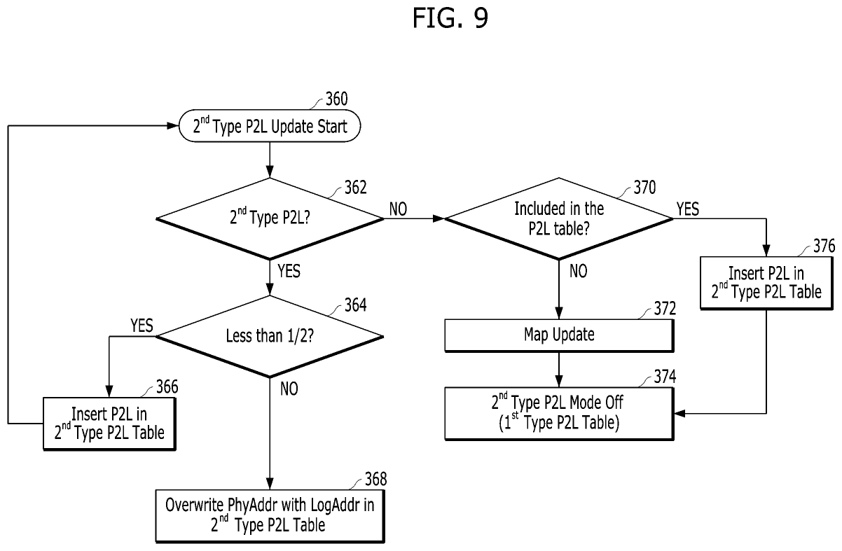

FIG. 9 illustrates a second example of a method for operating a memory system according to an embodiment of the disclosure. While FIG. 8 describes a method in which the memory system 110 determines a storage mode of the second map data (P2L table) stored in the memory 144, FIG. 9 shows a method for adding, controlling or managing a piece of second map information (P2L information) in the second map data (2nd Type P2L table) with the second storage mode controlled in the second storage mode within the memory 144 of the memory system 110.

Referring to FIG. 9, a method for operating a memory system starts an operation of adding a piece of second map information (P2L information) to the second map data (2nd Type P2L table) with the second storage mode after programming data to the memory device 150 in response to a write request (step 360). In this case, the second map data (2nd Type P2L table) may be controlled in the second storage mode. Here, the write request input from the host 102 may be a random write request or a sequential write request. After the memory system 110 programs data transferred with the write request to the memory device 150, the memory system 110 can generate a piece of second map information (P2L information) for associating a physical address, which indicates a location in which the data in the memory device 150 is stored, with a logical address associated with the programmed data and input from the host 102. The memory system 110 may perform an operation for adding the piece of second map information (P2L information) to the second map data (2nd Type P2L table) with the second storage mode.

In order to add the piece of second map information (P2L information) to the second map data (2nd Type P2L table) with the second storage mode, the memory system 110 can check whether it is suitable to add the piece of second map information (P2L information) to the second map data (2nd Type P2L table) with the second storage mode (step 362). For example, the memory system 110 can check whether the piece of second map information (P2L information) to be added to the second map data (2nd Type P2L table) with the second storage mode is generated though a write operation corresponding to a sequential write request or a random write request. According to an embodiment, the memory system 110 may check whether currently programmed data and previously programmed data are stored in the same open memory block.

If the piece of second map information (P2L information) is suitable for the second map data (2nd Type P2L table) with the second storage mode (YES in step 362), the memory system 110 determine how to add the piece of second map information (P2L information) to the second map data (2nd Type P2L table) controlled in the second storage mode. The memory system 110 may check whether the number of pieces of second map information (P2L information) added to the second map data (2nd Type P2L table) controlled in the second storage mode is less than ½ of the maximum number of pieces of second map information (P2L information) that can be added to the second map data (2nd Type P2L table) controlled in the second storage mode (step 364). For example, it is assumed that 20 pieces (e.g., 2*M pieces in FIG. 4) of second map information (P2L information) can be stored in the second map data (2nd Type P2L table) controlled in the second storage mode. If 8 pieces of second map information (P2L information) have been added in the second map data (2nd Type P2L table) controlled in the second storage mode (YES in step 364), a newly added piece (11th) of second map information (P2L information) may be added to the second map data (2nd Type P2L table) controlled in the second storage mode (step 366). But, if 10 pieces of second map information (P2L information) is stored in the second map data (2nd Type P2L table) controlled in the second storage mode (NO in step 364), the memory system 110 can overwrite some data stored in the second map data (2nd Type P2L table) in the second storage mode with the newly added piece (11th) of second map information (P2L information) (step 368). Referring to FIGS. 4 and 5, the physical address of the first piece of stored second map information (P2L information) may be overwritten with the logical address of the 11th piece of second map information (P2L information). Although not shown, after the 11th piece of second map information (P2L information) is added to the second map data (2nd Type P2L table) controlled in the second storage mode, the memory system 110 may go back to an operation for adding another piece of second map information (P2L information) corresponding to another write request (step 360).

If the piece of second map information (P2L information) is not suitable for the second map data (2nd Type P2L table) with the second storage mode (NO in step 362), the memory system 110 may check whether the piece of second map information (P2L information) can be added to the second map data (P2L table) of the current state (step 370). For example, when the second map data (P2L table) is the second map data (2nd Type P2L table) with the second storage mode, a piece of second map information (P2L information) may be generated based on a write operation corresponding to a random write request. Although the second map data (P2L table) is the second map data (2nd Type P2L table) with the second storage mode, the memory system 110 can check whether the piece of second map information (P2L information) including logical addresses and physical addresses can be added in the second map data (2nd Type P2L table) controlled in the second storage mode.

According to an embodiment, referring to FIGS. 4 and 5, the memory system 110 determines whether a piece of second map information (P2L information) can be added to the second map data (2nd Type P2L table) with the second storage mode (step 370). The process (step 370) is substantially the same as the process of determining whether the piece of second map information (P2L information) stored in the second map data (2nd Type P2L table) with the second storage mode is less than ½ of the maximum number of pieces of second map information (P2L information) that can be added to the second map data (2nd Type P2L table) with the second storage mode (step 364). For example, it is assumed that 20 pieces (e.g., 2*M pieces in FIG. 4) of second map information (P2L information) can be stored in the second map data (2nd Type P2L table) operating in the second storage mode. If 10 pieces of second map information (P2L information) are not yet stored, both logical and physical addresses of the piece of second map information (P2L information) can be added to the second map data (2nd Type P2L table) with the second storage mode, regardless of whether the piece of second map information (P2L information) are suitable for the second map data (2nd Type P2L table) controlled in the second storage mode. On the other hand, from or after the 11th piece of second map information (P2L information), whether to perform the map update may be determined according to whether the piece of second map information (P2L information) is suitable for the second map data (2nd Type P2L table) controlled in the second storage mode. For example, the ninth second map information (P2L information) (YES in step 370) that is not suitable for the second map data (2nd Type P2L table) operating in the second storage mode may be added to the second map data (2nd Type P2L table) in the second storage mode (step 376). In a case of 11th second map information (P2L information) (NO in step 370) that is not suitable for the second map data (2nd Type P2L table) operating in the second storage mode, the memory system 110 may perform the map update (step 372).

If there is an available space in the second map data (2nd Type P2L table) operating in the second storage mode to store a piece of second map information (P2L information) including both the logical address and the physical address (YES in step 370), the memory system 110 may add the piece of second map information (P2L information) including both logical and physical addresses to the second map data (2nd Type P2L table) controlled in the second storage mode (step 376). Through this, the memory system 110 can reduce a frequency of changing or adjusting the storage mode of the second map data (P2L table), and it can be avoided to bring forward the map update or map flush. As a result, the memory system 110 can reduce overhead incurred in data input/output operations.

On the other hand, if there is no available space to store the second map information (P2L information) including both the logical address and the physical address in the second map data (2nd Type P2L table) operating in the second storage mode (NO in step 370), the memory The system 110 may perform the map flush or map update based on the second map data (step 372). After the map flush or map update is performed based on the second map data, the memory system 110 does not need to maintain the second map data. The memory system 110 may delete, destroy, or release items of the second map data used for performing the map flush or map update.

After the memory system 110 adds a piece of second map information (P2L information) that is not suitable for the second map data (2nd Type P2L table) operating in the second storage mode (step 376), or the map flush or map update is performed (step 372), the storage mode of the second map data is changed from the second storage mode (2nd Type) to the first storage mode (1st Type) (step 374). Although not shown, referring to FIG. 5, after the memory system 110 changes the storage mode of the second map data (P2L Table) from the second storage mode (2nd Type) to the first storage mode (1st Type), the storage mode of the second map data (P2L Table) may no longer be changed before the map update or map flush is performed.

As described above, when the second map data (2nd Type P2L table) operates in the second storage mode, the memory system 110 may add a piece of second map information (P2L information) to the second map data (2nd Type P2L table) with the second storage mode or perform the map update. According to an embodiment, the map update may be determined according to the storage mode of the second map data (P2L table) and the type of write requests, each generating a piece of second map information (P2L information).

Depending on the type of write requests, it may be determined whether the generated piece of second map information (P2L information) is suitable for being added to the second map data (2nd Type P2L table) having the second storage mode. The number of pieces of second map information (P2L information) that may be stored in the second map data (P2L table) may vary according to the storage mode of the second map data (P2L table). In addition, whether to add the piece of second map information (P2L information) to the second map data (P2L table) may vary according to the type of write requests generating second map information (P2L information).

If the storage mode of the second map data (P2L table) is frequently changed when the second map data (P2L table) may operate in one of a plurality of storage modes, overhead might not be reduced during data input/output operations performed by the memory system 110. Through the operation method of the memory system described with reference to FIG. 8 according to an embodiment of the disclosure, a count of changing a storage mode of the second map data (P2L table) can be reduced, and the map flush or map update based on the second map data (P2L table) can be maintained or delayed.

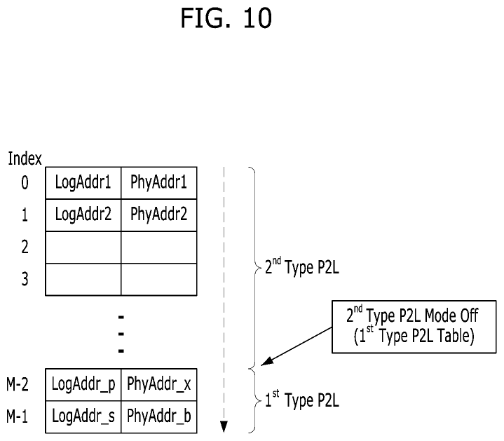

FIG. 10 illustrates map data including second map information (P2L information) corresponding to different types of write requests in a memory system according to an embodiment of the disclosure. Referring to FIGS. 4 to 9, the second map data (P2L table) in the memory 144 includes plural pieces of second map information (P2L information) generated through operations corresponding to different types of write requests.

Referring to FIG. 4, pieces of second map information (P2L information) corresponding to different types of write requests may be stored in the second map data (P2L table) by changing the storage mode regarding the second map data (P2L table). According to an embodiment, both a logical address LogAddr1 and a physical address PhyAddr1 corresponding to a piece of second map information (P2L information), generated after an operation corresponding to the random write request is performed, may be added in the second map data (1st Type P2L table) with the first storage mode. On the other hand, only the logical address LogAddr1 within a piece of second map information (P2L information) generated after an operation corresponding to the sequential write request may be added in the second map data (2nd Type P2L table) with the second storage mode, without the physical address PhyAddr1 associated with the logical address LogAddr1 corresponding to the piece of second map information (P2L information).

Referring to FIG. 9, when the second map data (P2L table) in the memory 144 operates in the second storage mode (2nd Type), a piece of second map information (P2L information) may be generated after a write operation corresponding to a random write request is performed (NO in step 362). In this case, when it is determined that the piece of second map information (P2L information) may be added to the second map data (2nd Type P2L table) with the second storage mode (YES in step 370), the second map information (P2L information) including the logical address LogLogr1 and the physical address PhyAddr1 may be added to the second map data (2nd Type P2L table) operating in the second storage mode.

FIG. 10 shows a case when two pieces of second map information (P2L information) generated by operations corresponding to two random write requests are further added to the second map data (2nd Type P2L table) operating in the second storage mode, after plural pieces of second map information (P2L information) generated by write operations corresponding to a plurality of sequential write requests is sequentially added. Referring to FIG. 10, a write operation corresponding to a random write request can be performed after the plural pieces of second map information (P2L information) generated after the write operations corresponding to the plurality of sequential write requests are sequentially added to second map data (2nd Type P2L table) controlled in the second storage mode. When there is more than ½ of available space where another piece of second map information (P2L information) can be stored in the second map data (2nd Type P2L table) operating in the second storage mode (that is, the second map data storing less than M pieces of second map information (P2L information)), the piece of second map information (P2L information) including both a logical address and a physical address corresponding to the random write request may be added. In this case, overwrite is not performed. After a piece of data associated with the first random write request among the two random write requests is programmed in the memory device 150, the memory system 110 generates a single piece of second map information (P2L information) including a logical address LogAddr_p and a physical address PhyAddr_x. If there is a storage space (empty space) in the second map data (2nd Type P2L table) operating in the second storage mode, the memory system 110 may add the piece of second map information (P2L information) including the logical address LogAddr_p and the physical address PhyAddr_x as the (M−1)th piece of second map information (P2L information), even though the piece of second map information (P2L information) is generated by the program operation performed without the map update after the write operations corresponding to the plurality of sequential write requests.

Referring to FIG. 9, after adding the piece of second map information (P2L information) including the logical address LogAddr_p and the physical address PhyAddr_x in the second map data (2nd Type P2L table) with the second storage mode, the memory system 110 may set the storage mode of the second map data (P2L table) as the first storage mode. A piece of second map information (P2L information) corresponding to the second random write request among the two random write requests includes a logical address LogAddr_s and a physical address PhyAddr_b. The piece of second map information (P2L information) including the logical address LogAddr_s and the physical address PhyAddr_b may be added as the Mth piece of second map information (P2L information) to the second map data (1st Type P2L table) changed to the first storage mode.

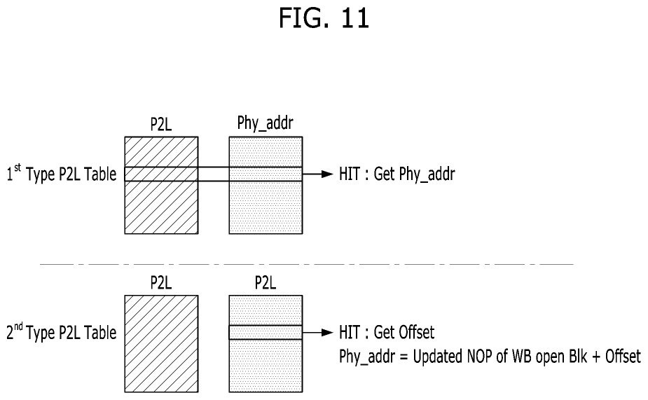

FIG. 11 illustrates a third example of a method for operating a memory system according to an embodiment of the disclosure. FIG. 11 shows a method for performing a read operation based on the second map data (P2L table) in the memory 144 or using the second map data (P2L table) for the map update.

Referring to FIGS. 4 and 11, the second map data (P2L table) in the memory 144 may operate in different storage modes. According to an embodiment, a piece of second map information (P2L information) included in the second map data (1st Type P2L table) operating in the first storage mode may include a logical address LogAddr and a physical address PhyAddr. For example, before the map flush or map update is performed, when a read request for data associated with a piece of second map information (P2L information) included in the second map data is received, the memory system 110 can perform a read operation corresponding to the read request based on the second map data having more recent information than the first map data (L2P table). The memory system 110 can check whether the logical address transmitted with the read request is included in the second map data, and obtain a physical address from the piece of second map information (P2L information) associated with the matching logical address (Get PhyAddr).

In addition, because the piece of second map information (P2L information) included in the second map data (1st Type P2L table) operating in the first storage mode includes the logical address (LogAddr) and the physical address (PhyAddr), the memory system 110 performing the map update or map flush can distinguish which part of the first map data (L2P table) in the memory device 150 should be updated based on the logical address.

The piece of second map information (P2L information) included in the second map data (2nd Type P2L table) operating in the second storage mode may include the logical address LogAddr only without the physical address PhyAddr. Although the physical address PhyAddr is not included in the second map data (2nd Type P2L table) operating in the second storage mode, plural pieces of second map information (P2L information) can be distinguished by an index, order, or sequence in the second map data (2nd Type P2L table) with the second storage mode because sequential addition of the second map information (P2L information) to the second map data (2nd Type P2L table) with the second storage mode. In addition, the second map information (P2L information) might not have information about a memory block (e.g., block number) in which data in the memory device 150 is stored, but the memory system 110 has information about specific open memory block (Updated NOP of WB open Blk) that write operations corresponding to sequential write requests is performed. Accordingly, when the information about the specific open memory block is combined with the offset indicating a sequence or an order of logical addresses (LogAddr) included in the second map data (2nd Type P2L table) operating in the second storage mode, the memory system 110 may find a location where each piece of data is actually stored. In this way, the memory system 110 can perform the map update for updating the first map data (L2P table) based on the second map data (P2L table), or perform address translation in response to a read request based on the second map data (P2L table) which is the latest second map information (P2L information) corresponding to the logical address.

The memory system according to an embodiment of the disclosure can change a storage mode regarding the map data temporarily stored in the cache memory or the volatile memory so as to control the cache memory or the volatile memory efficiently.

Further, the memory system according to another embodiment of the disclosure may add more second map information (P2L information) to the map data stored in the cache memory or the volatile memory, so that a timing for the map update in the memory system can be delayed and data input/output performance can be improved or enhanced.

In addition, the memory system according to another embodiment of the disclosure may change the storage mode regarding the map data stored in a cache memory or a volatile memory, based on a type of write requests, to improve a data input/output speed of the memory system, thereby improving or enhancing performance of the memory system.

While the present teachings have been illustrated and described with respect to the specific embodiments, it will be apparent to those skilled in the art in light of the present disclosure that various changes and modifications may be made without departing from the spirit and scope of the disclosure as defined in the following claims.

What is claimed is:

1. A memory system, comprising:
a memory device including at least one open memory block; and
a controller configured to:
program data input along with write requests from an external device in the at least one open memory block,
determine a storage mode regarding map data based on a type of the write requests, and
perform a map update based on the map data,
wherein the controller is further configured to determine a timing for performing the map update based on the storage mode and the type of write requests.

2. The memory system according to claim 1, wherein a number of the at least one open memory block where the data input along with the write requests is programmed depends on the type of write requests.

3. The memory system according to claim 1, wherein the write requests include a random write request and a sequential write request, and data corresponding to the sequential write request is programmed in a single open memory block of the at least one open memory block.

4. The memory system according to claim 3,
wherein the memory device includes a plurality of planes, each plane including at least one buffer capable of storing data having a size of page, and
wherein the plane includes the at least one open memory block individually.

5. The memory system according to claim 1, wherein the map data includes plural pieces of second map information, each piece of second map information linking a physical address to a logical address.

6. The memory system according to claim 5, wherein the controller is configured to determine the storage mode as one of:
a first storage mode where the logical address and the physical address corresponding to each piece of second map information are stored in the map data; and
a second storage mode where only the logical address corresponding to each piece of second map information is stored in the map data and the physical address associated with the stored logical address is recognized by an index of the stored logical address within the map data.

7. The memory system according to claim 6, wherein the controller is further configured to maintain the storage mode, even when the type of write requests is changed, when the storage mode regarding the map data is the first storage mode.

8. The memory system according to claim 6,
wherein the controller is further configured to either add a new piece of second map information to the map data or perform the map update according to the type of write requests and an available space within the map data when the storage mode regarding the map data is the second storage mode; and
wherein the controller is further configured to add the new piece of second map information to the map data by adding the logical address and the physical address corresponding to the new piece of second map information to the map data or overwriting a physical address stored in the map data with the logical address corresponding to the new piece of second map information.

9. The memory system according to claim 5,
wherein the memory device stores first map data, and
wherein the map update includes an operation of updating the first map data based on the second map information when the map data is not available for storing a new piece of second map information.

10. A method for operating a memory system, comprising:
programming data in a memory device including at least one open memory block according to a type of write requests input from an external device;
determining a storage mode regarding map data based on the type of write requests; and
performing a map update based on the map data,
wherein the performing of the map update includes determining a timing for performing the map update based on the storage mode and the type of write requests.

11. The method according to claim 10, wherein a number of the at least one open memory block where the data input along with the write requests is programmed depends on the type of write requests.

12. The method according to claim 10, wherein the write requests include a random write request and a sequential write request, and data corresponding to the sequential write request is programmed in a single open memory block of the at least one open memory block.

13. The method according to claim 10,
wherein the memory device includes a plurality of planes, each plane including at least one buffer capable of storing data having a size of page, and
wherein the plane includes the at least one open memory block individually.

14. The method according to claim 10, wherein the map data includes plural pieces of second map information, each piece of second map information linking a physical address to a logical address.

15. The method according to claim 14, wherein the storage mode is determined as one of:
a first storage mode where the logical address and the physical address corresponding to each piece of second map information are stored in the map data; and
a second storage mode where only the logical address corresponding to each piece of second map information is stored in the map data and the physical address associated with the stored logical address is recognized by an index of the stored logical address within the map data.

16. The method according to claim 15, further comprising maintaining the storage mode, even when the type of write requests is changed, when the storage mode regarding the map data is the first storage mode.

17. The method according to claim 15, further comprising: either adding a new piece of second map information to the map data or performing the map update according to the type of write requests and an available space within the map data when the storage mode regarding the map data is the second storage mode; and
wherein the adding of the new piece of second map information to the map data includes adding the logical address and the physical address corresponding to the new piece of second map information to the map data or overwriting a physical address stored in the map data with the logical address corresponding to the new piece of second map information.

18. The method according to claim 14,
wherein the memory device stores first map data, and
wherein the map update includes an operation of updating the first map data based on the second map information when the map data is not available for storing a new piece of second map information.

19. A controller for generating first map information and second map information used to associate different address schemes with each other for engaging plural devices with each other, each device having a different address scheme, causes one or more processors to perform operations comprising:
programming data in a memory device including at least one open memory block according to a type of write requests input from an external device;
determining a storage mode regarding map data based on the type of write requests; and
performing a map update based on the map data,
wherein the performing of the map update includes determining a timing for performing the map update based on the storage mode and the type of write requests.

20. The controller according to claim 19,
wherein, when the write requests are sequential write requests, data input along with the write requests is programmed in a single open memory block, and
wherein the determining of the storage mode includes controlling the map data regarding second map information associating a physical address with a logical address in a storage mode where only the logical address is recorded in the map data and the physical address associated with the recorded logical address is recognized by an index of the recorded logical address within the map data.
